(19) United States
(12) Patent Application Publication
(10) Pub. No.: US 2025/0205809 A1
(43) Pub. Date: Jun. 26, 2025

(54) FRICTION STIR WELDING (FSW) APPARATUS AND TECHNIQUES

(71) Applicant: Battelle Memorial Institute, Richland, WA (US)

(72) Inventors: Piyush Upadhyay, Richland, WA (US); Curt A. Lavender, Richland, WA (US); Md. Reza-E-Rabby, West Richland, WA (US); Mitch L. Blocher, Richland, WA (US); Glenn J. Grant, Benton City, WA (US); Hrishikesh Das, Richland, WA (US); Zachary F. Huber, Richland, WA (US); Vineet V. Joshi, Richland, WA (US); Ayoub Soulami, Richland, WA (US); Kyoo Sil Choi, Richland, WA (US)

(21) Appl. No.: 18/978,287

(22) Filed: Dec. 12, 2024

Related U.S. Application Data
(60) Provisional application No. 63/609,104, filed on Dec. 12, 2023.

(51) Int. Cl. B23K 20/12

(52) U.S. Cl. CPC B23K 20/129; B23K 20/1255; B23K 20/1265

(57) ABSTRACT

A Friction Stir Welding (FSW) approach can be used to join two structures, such as a plate to a base structure, or two portions of a wall of a structure such as a tubular structure (e.g., a pipe or vessel). According to various examples, FSW can be used for forming welds on an exterior-facing portion of a structure (e.g., externally), or on an interior-facing portion of a structure, such as within a confined environment. As an example, FSW can be performed within the confined environment using a compact spindle configuration as shown and described herein. FSW generally refers to a solid-phase processing technique where a tool is applied to a work piece, with rotation of the tool relative to the workpiece along with application of a forging force to drive a face of the tool into the workpiece to frictionally induce plastic deformation of material.

### CLAIM OF PRIORITY

This patent application claims the benefit of priority of Upadhyay et al., U.S. Provisional Patent Application No. 63/609,104, titled “FRICTION STIR PIPE WELDING FOR INVOLUTE NUCLEAR FUELS AND HEAT EXCHANGERS,” filed on Dec. 12, 2023 (Attorney Docket No. 6323.042PRV), which is hereby incorporated by reference herein in its entirety.

### STATEMENT REGARDING FEDERALLY SPONSORED RESEARCH OR DEVELOPMENT

This invention was made with government support under DE-AC05-76RL01830 awarded by the U.S. Department of Energy. The government has certain rights in the invention.

### FIELD OF THE DISCLOSURE

This document pertains generally, but not by way of limitation, to solid-phase material processing, and more particularly, to apparatus and techniques for Friction Stir Welding (FSW) that can be applied to performing welding operations on flat and tubular structures, such as on exterior or interior-facing portions of tubular structures.

### BACKGROUND

Various structures such as nuclear reactor fuel assemblies or heat exchangers can include welded joints, such as between plate-shaped structures and a base structure or substrate. In one approach, such welded joints can be formed using fusion welding, where at least one material is melted in order to form the weld. One class of fusion welding is Gas Metal Arc Welding (GMAW), as an example.

Some nuclear reactor core configurations include use of a fuel assembly where cladded fuel plates are welded to tubular side plates as part of a fabrication process. For example, hundreds of involute fuel plates can be radially arranged around annular metal tubes and locked into position using welded joints. To ensure spatial stability during the installation and operation of the reactor, the fuel plates are typically specified to tolerate a minimum pull-out strength and may have other stringent dimensional specifications. Fusion welding techniques such as GMAW can be used for the joining of the fuel plates to the tubular side plates as an example of an existing approach. Another example of a welding approach that is applicable to involute fuel plate welding is electron beam (e-beam) welding. An e-beam welding approach generally involves use of a localized vacuum to avoid scattering and can present various challenges.

Other structures also use fusion-welded joints according to existing fabrication approaches. For example, enclosed structures such as reactor vessels or open tubular structures such as pipes can include walls comprising welded seams.

### SUMMARY OF THE DISCLOSURE

The present subject matter can include or use of a Friction Stir Welding (FSW) approach. The FSW approach can be used to join two structures, such as a plate to a base structure, or two portions of a wall of a structure such as a tubular structure (e.g., a pipe or vessel). According to various examples, FSW can be used for forming welds on an exterior-facing portion of a structure (e.g., externally), or on an interior-facing portion of a structure, such as within a confined environment. As an example, FSW can be performed within the confined environment using a compact spindle configuration as shown and described herein. FSW generally refers to a solid-phase processing technique where a tool is applied to a work piece, with rotation of the tool relative to the workpiece along with application of a forging force to drive a face of the tool into the workpiece to frictionally induce plastic deformation of material. Such plastic deformation can be associated with mixing, forming a joint between two structures.

The present inventors have recognized that liquid-phase fusion welding approaches can present various challenges. For example, in fabrication of a nuclear reactor fuel assembly, fusion welds can induce large thermal gradients due to an inherently large amount of heat input, causing excessive residual stresses. This can result in significant distortion of the metal structure such as tubes, resulting in core geometry change and even dislodging of fuel plates from tube slots. These geometrical fluctuations can result in a lowering of core efficiency requiring reworking of the assembly, or non-conformance reporting and sometimes rejection of the element.

By contrast, using FSW apparatus and techniques as shown and described herein, a nuclear reactor fuel plate assembly can be fabricated, such as having a base structure comprising annular Aluminum (Al) piping. Illustrative examples of plates that have joined to base structures as shown and described herein show, for example, defect-free solid-state bonding of Al tube (e.g., a base structure) to Al fuel plate (e.g., a plate extending outward from the base structure), having a pull strength higher than 100 pound-force (Lbf) or approximate 444.8 Newton (N). Due to reduced heat input associated with FSW, thermal distortion of the Al tube is significantly lower than what can be obtained using fusion welding. Welds can be performed in a circumferential direction around a tubular structure (e.g., circular or spiral weld path configurations), or in an axial direction along a long axis of the tubular structure, or combinations thereof.

The present inventors have recognized, among other things, that aspects of the present subject matter including tool geometry and welding parameters can be established to provide high-quality joints with reduced or minimal distortion as compared to fusion welding. The present approach can be applied to various structures having plates extending from a base structure, such as associated with the assembly of research reactor or other reactor fuel elements, heat exchanger structures, or pipe structures (e.g., for hydrogen or other commodities) as illustrative examples.

Another aspect of the present subject matter can include FSW apparatus, such as a spindle configuration for operation within a confined area, such as within a structure where welding is performed. For example, the present inventors have recognized, among other things, that no solutions or approaches exist for producing FSW joints in confined structure geometries. For example, generally available FSW systems are too bulky for such confined applications. FSW joints are generally made from the outside of a structure (e.g., processing an exterior-facing surface of the structure). Exterior joints may not be most desirable or even feasible where the structure geometry may not allow access or a higher-class finish may be specified, such as in the case of joining pipe. In one approach, fusion welding is used, but as mentioned above, fusion welding can have thermal disadvantages, and also may involve more costly preparation such as involving use of notched joints, which increases cost and processing complexity as compared to the FSW approach described herein.

Use of a compact spindle configuration as shown and described herein can enable numerous applications, including fabrication of nuclear fuel components, heat exchangers, oil and gas pipelines, or both structural and nonstructural pipe and tube manufacturing, as illustrative (but non-limiting) examples. As an illustration, use of a compact spindle that performs FSW on an interior-facing surface can facilitate fabrication of “seamless” pipe with a hidden internal seam. Depending on the application, use of the compact spindle for FSW does not necessarily require a backing plate, particularly where less penetration is occurring by a tool driven by the spindle. The compact spindle configuration can support a repeatable and precise weld similar to exterior FSW welding, but in a more compact and versatile welding system form factor, producing stronger joints than fusion welding. According to an example, the compact spindle can be mated with an existing FSW machine, such as driven by the FSW tool prime mover or manipulated using a gantry associated with an existing FSW machine, as examples. Use of the compact spindle assembly as shown and described herein is not restricted to joining walls of a structure together, and can include, for example, welding a nozzle, valve body, or other structure to a tubular structure such as a pipe or vessel.

In an example, an apparatus can be used for performing friction stir welding (FSW) on an interior face of a workpiece, the apparatus comprising a support arm coupled with or comprising a spindle housing, a spindle shaft, supported by the spindle housing, and a tool removably coupled to the spindle shaft, the tool comprising a pin protruding outward from a face of the tool. The spindle shaft and tool can be oriented to extend laterally outward from the support arm to engage an interior face of a workpiece where a forging force and rotation between a tool and the workpiece are established, and the support arm, spindle shaft, spindle housing, and tool can be sized and shaped to fit within a cross section defined by the workpiece when extended within the workpiece by the support arm.

In an example, a tool for friction stir welding (FSW) can be used plastically deform and mix, in a solid phase, a material, when the tool is subject to a forging force and rotation relative to the material, the tool comprising a shank configured to be engaged by a tool holder, a face defined by a body of the tool, the face defining a shoulder extending along the face from an edge of the tool inward toward a center of the face, a pin protruding outward from the face of the tool centered at the center of the face; and at least one spiral feature defined by a protrusion or a recess extending outward or inward from a face of the tool in an axial direction parallel to the forging force, the at least one spiral feature located between the shoulder and the pin.

In an example, a technique, such as a method for forming a tubular structure using friction stir welding (FSW), can include establishing a forging force and rotation between a tool and two adjacent portions of a wall for the tubular structure to plastically deform and mix, in a solid phase, material comprising the two adjacent portions to form a joint between the two adjacent portions, contemporaneously with the establishing the forging force and the rotation, establishing translation of the tool relative to the tubular structure to continue the joint to form a seam extending along an interface formed by the two adjacent portions of the wall. The forging force and rotation can be established on interior-facing regions of the two adjacent portions of the wall such as using a compact spindle configuration.

In an example, a technique, such as a method for forming a joint using friction stir welding (FSW), can include positioning a plate against a first face of a base structure, the plate extending outward from the first face of the base structure, establishing a forging force and rotation between a tool and a second face of the base structure opposite the first face to plastically deform and mix, in a solid phase, through the base structure, material comprising the base structure and material comprising the plate to form a joint between base structure and the plate, and contemporaneously with the establishing the forging force and the rotation, establishing translation of the tool relative to the second face of the base structure to define a specified weld path. The first plate can be amongst a plurality of plates extending outward from the first face of the base structure, and the establishing translation of the tool relative to the second face of the base structure along a weld path can form respective joints between the plurality of plates and the base structure.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A, FIG. 1B, and FIG. 1C illustrate generally examples that can include or use a friction stir welding (FSW) apparatus, such as for performing a welding operation on a base structure to join a plate extending from the base structure to the base structure.

FIG. 2A and FIG. 2B illustrate generally views of a friction stir welding apparatus that can be used to form a joint between a plurality of plates and a base structure.

FIG. 3 shows a view of an illustrative example comprising a tool that can be used to perform a friction stir welding (FSW) operation.

FIG. 4A, FIG. 4B, and FIG. 4C illustrate generally different views of another illustrative example comprising a tool that can be used to perform a friction stir welding (FSW) operation.

FIG. 4D and FIG. 4E show further illustrative examples comprising tool that can be used to perform a friction stir welding (FSW) operation.

FIG. 5A, FIG. 5B, FIG. 5C, and FIG. 5D show illustrative examples of views of transverse cross-sectioned structures comprising friction stir welded joints using a technique as described in FIG. 1A, FIG. 1B, FIG. 1C, FIG. 2A, and FIG. 2B.

FIG. 5E and FIG. 5F show illustrative examples of views of longitudinal cross-sectioned structures comprising friction stir welded joints using a technique as described in FIG. 1A, FIG. 1B, FIG. 1C, FIG. 2A, and FIG. 2B.

FIG. 6A, FIG. 6B, and FIG. 6C show different views of an illustrative example comprising a rest support that can be used to support a workpiece on which a friction stir welding (FSW) is being performed.

FIG. 7A and FIG. 7B show different views of a friction stir welding (FSW) system that can be used to perform FSW operations as shown a described elsewhere herein.

FIG. 8A illustrates generally a tubular structure on which a friction stir welding (FSW) tool has been used to form a weld along a spiral weld path.

FIG. 8B illustrates generally a tubular structure on which a friction stir welding (FSW) tool has been used to form respective circumferential welds.

FIG. 9A, FIG. 9B, and FIG. 9C illustrate respective parameters used for forming a weld on 5.5 in. OD pipe.

FIG. 10A, FIG. 10B, and FIG. 10C illustrate respective parameters used for forming a weld on 8 in. OD pipe.

FIG. 11A illustrates generally a configuration for a portion of an illustrative example comprising a nuclear reactor core fuel assembly, such as for use with the High Flux Isotope Reactor (HFIR), including cylindrical side plates, and involute fuel plates extending therebetween.

FIG. 11B illustrates generally forces used for performing a friction stir welding (FSW) operation on a face of a side place comprising an aluminum mock-up of a fuel element as shown in FIG. 2A.

FIG. 12A illustrates generally an example comprising a compact spindle assembly and support frame that can be coupled to a prime mover.

FIG. 12B illustrates generally a cross-sectional view of the compact spindle assembly and friction stir welding (FSW) tool, within a tubular structure.

FIG. 12C and FIG. 12D illustrate generally respective views of a spindle shaft of the compact spindle assembly, with a side view shown in FIG. 12C and a corresponding section view shown in FIG. 12D to illustrate coolant passages and internal configuration.

FIG. 12E illustrates generally a static portion of the compact spindle assembly of FIG. 12A and FIG. 12B.

FIG. 12F illustrates generally a spindle housing of the compact spindle assembly of FIG. 12A and FIG. 12B.

FIG. 12G illustrates generally a cup of the compact spindle assembly that can establish cooling passages.

FIG. 13 illustrates generally a technique, such as a method for performing a friction stir welding (FSW) to form a tubular structure such as a pipe.

FIG. 14 illustrates generally an illustrative example of a technique to form a tubular structure from flat material (e.g., sheet) according to the method of FIG. 13, where a spiral weld configuration is used.

FIG. 15 illustrates generally an illustrative example of a technique to form a tubular structure from flat material (e.g., sheet) according to the method of FIG. 13, where a longitudinal weld configuration is used.

### DETAILED DESCRIPTION

Friction stir welding (FSW) is a solid-phase technique that can be used to produce a welded joint using a non-consumable tool, such as without requiring surface preparation or an external heat source. In an FSW operation, heat is generated by localized friction and plastic deformation and no melting occurs. Accordingly, overall heat input and time at peak temperature are significantly lower than for fusion-based welding methods. An FSW welding system can traverse (e.g., move the welding tool across the work piece) at relatively high speed compared with a fusion welding approach. For example, such traverse can occur at a velocity within a range of about 0.3 m/min to 2 m/min, as an illustrative but non-limiting example. An FSW welding process is suitable for automation and accordingly, does not generally require highly trained operators, once process parameters have been established.

The present subject matter includes illustrative examples demonstrating that FSW is capable of effectively joining plate structure to a base structure, in a linear mockup corresponding to a portion of a nuclear reactor core fuel assembly. Pull tests performed on the experimentally-produce FSW joints demonstrate that a through-wall FSW technique provides pull strength that exceeds fuel element requirements specified for operation in a High Flux Isotope Reactor (HFIR) application, as an illustrative example.

Metallographic inspection of experimentally obtained joint cross-sections was found to be defect free and well bonded. Further examples described herein include circumferential hollow pipe welding in circular and spiral welding paths on a 5.5 in. (13.97 cm) and 8 in. (20.32 cm) outer diameter (OD) pipes. As an illustrative example, two steady rests were also fabricated that can receive a pipe with a maximum OD of 9 in (22.86 cm). A long spiral and several circular circumferential FSWs were demonstrated at a welding speed of 0.5 m/min with a nominal plunge depth of 0.079 in (2.0 mm) and 0.2 in (5.1 mm) for 5.5 in. OD and 8 in. OD pipes, respectively. A compact spindle configuration is also discussed in this document, facilitating FSW operations on inward-facing (e.g., interior or confined) portions of a structure, such as facilitating FSW on surface within a confined space, such as an interior-facing surface of a tubular structure or other structure that can have an enclosed cross section.

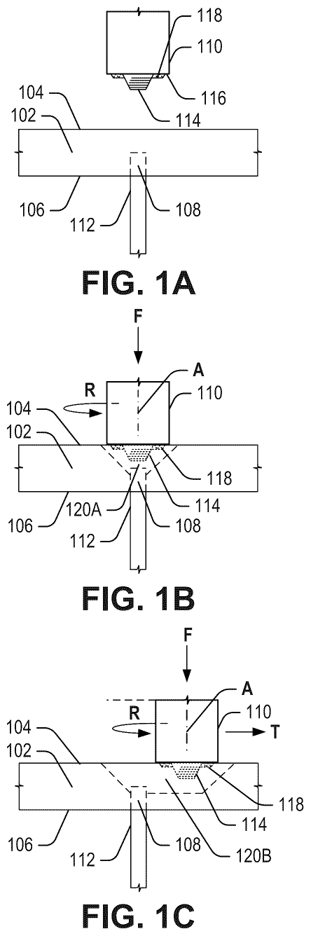

FIG. 1A, FIG. 1B, and FIG. 1C illustrate generally examples that can include or use a friction stir welding (FSW) apparatus, such as for performing a welding operation on a base structure 102 to join a plate 112 extending from the base structure 102 to the base structure 102. For example, the plate 112 can extend outward from a first face 106 of the base structure 102. The plate 112 can be positioned against the first face 106, such as within a cavity or slot 108. A friction stir welding (FSW) tool 110 can be advanced toward the base structure 102.

For example, the tool 110 can include or define a shoulder 116, such as extending toward one or more grooves or other features, such as a scroll feature 118 (e.g., a spiral) extending outward or inward from a face of the tool 110. The tool 110 can include a pin 114 extending outward from a face of the tool 110, such as protruding outward and having a tapered profile. Referring to FIG. 1B in particular, the tool 110 can be rotated (as noted by the rotation, R) contemporaneously with application of a forging force F. In FIG. 1B and FIG. 1C, the tool 110 is show as oriented such that an axial direction corresponding to the tool 110 long axis and the forging force, F, are both normal (e.g., perpendicular) to a second face 104 of the base structure 102. Such an orientation is an illustrative example, and according to the present subject matter, the tool 110 can be tilted slightly off normal. For example, when forming a joint in a tubular base structure, a positive tool tilt angle can be established by establishing a plunge in a location laterally offset an outer surface of the tubular structure (e.g., along a tangent line, but not at a tangent location on the tubular structure, so that the tool 110 angle is off normal where the pin 114 engages a surface of the tubular structure.

Referring to FIG. 1B, the contemporaneous rotation, R, and forging force, F, established between the tool 110 and the base structure 102, applied by features of the tool 110 such as the protruding pin 114, cause heating and solid-phase plastic deformation of material comprising the base structure 102. Depending on a plunge depth of the tool 110 and penetration of the plate 112, material comprising the plate 112 will also be plastically deformed and mixed locally in a weld region 120A with material comprising the base structure 102. In this manner, a joint can be formed between the plate 112 and the base structure 102 from by application of the tool 110 on a second face 104 of the base structure 102 opposite the first face 106.

Referring to FIG. 1C, the tool 110 can be translated contemporaneously with application of the forging force, F, and rotation, R, such as to follow a contour of the second face 104 to define a weld path. As shown illustratively in FIG. 1C, such translation, T, can occur parallel to the second face 104, extending the weld to a weld region 120B. In summary, the examples of FIG. 1A, FIG. 1B, and FIG. 1C can represent operations forming a portion of a method for performing FSW, and associated apparatus, where FIG. 1A can represent positioning of the plate 112 against the base structure 102, FIG. 1B can represent contemporaneous rotation and application of the forging force, and FIG. 1C can represent contemporaneous translation of the tool 110 with rotation and application of the forging force.

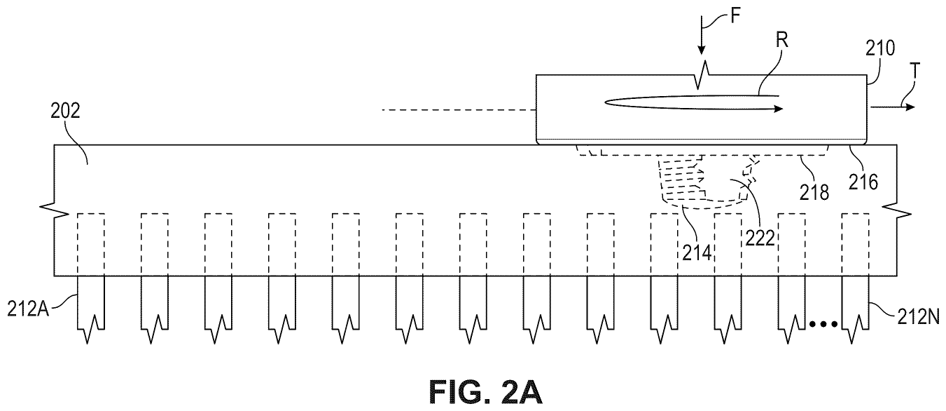

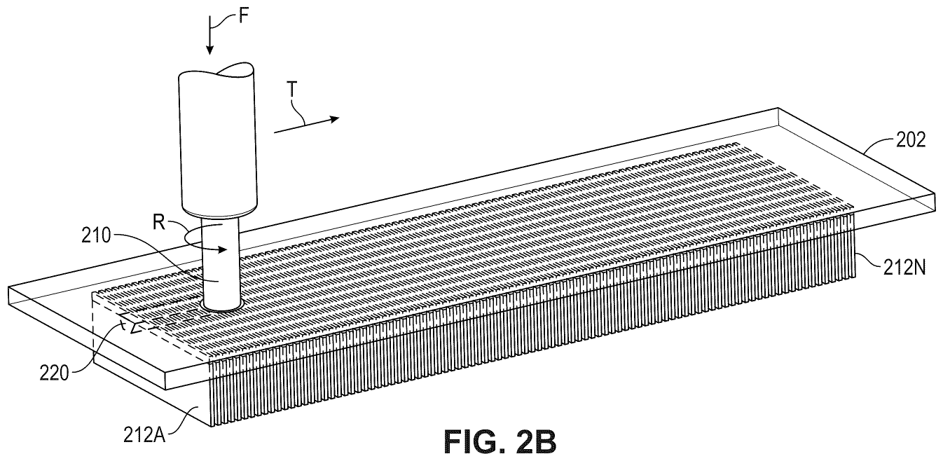

FIG. 2A and FIG. 2B illustrate generally views of a friction stir welding apparatus that can be used to form a joint between a plurality of plates and a base structure. For certain applications, such as for fabrication of a portion of a nuclear reactor core fuel assembly, hollow aluminum tubes can be fabricated having specified dimensions, and such tubes can be machined with longitudinal inner grooves to receive involute-shaped fuel plates, as discussed elsewhere herein. Once the involute fuel plates are assembled into the grooves, the assembly can be loaded and centered on a chuck (connected to a rotary system). The tube can also be supported using multiple steady rests with rollers that are arranged to react to the FSW process forces in three axes (e.g., X, Y, and Z direction, where Z direction represents a forging or plunge force). A linear mock-up of such a configuration is shown illustratively in FIG. 2A and FIG. 2B.

For example, an FSW tool 210 can include or define a pin 214 protruding outward from a face of the FSW tool 210. As an illustrative but non-limiting example, the pin 214 can have a length ranging from about 20% to about 70% of a thickness of the base structure 202 (shown as linear in FIG. 2A, but in some applications, the base structure 202 can be tubular or curved). In another example, the pin can penetrate through 100% or nearly 100% of the base structure, such as where a backer or other structure is located on the opposite face of the base structure.

The pin 214 can be plunged into the aluminum base structure 202 corresponding to a forging force, F, and contemporaneous rotation, R, can be provided. As a shoulder 216 and associated scroll feature 218 of the FSW tool 210 contacts a surface of the base structure 102, the material around a protruding pin 214 of the FSW tool gets plasticized and forged around the plate resulting in bonding between the base structure 202 and fuel plate. The pin 214 can have one or more flat regions (e.g., a region 222), such as to facilitate mixing or movement of plasticized material as discussed further below.

Relative motion between the base structure 202 and tool can be used to establish a weld path having a linear (e.g., axial), circular (e.g., circumferential), or spiral configuration, such that multiple joints between respective plates 212A through 212N and base structure 202 are formed at a specified pitch (e.g., a specified distance along a surface of the base structure 202 between joints). For example, a weld region 220 need not extend along an entire lateral edge of a respective plate and can extend across multiple plates as shown in FIG. 2B, for example, where the FSW tool 210 exerts a forging force, F, against the base structure 202 contemporaneously with rotation, R, and translation in the direction T. In this manner, a joint is formed in the weld region 220 along a linear weld path across the respective plates 212A through 212N, forming joints at the locations where the plates 212A through 212N intersect the weld path.

As illustrative examples, an FSW process can be run in Z force or position control with or without closed-loop temperature control. For example, a tool 210 temperature can be monitored and controlled using one or more thermocouples placed at different locations on, within, or near an FSW tool 210. The FSW tool 210 can be configured to reduce downward forging force (e.g., a force F such as referred to as the Z axis or plunge axis in a fixed coordinate frame relative to an FSW machine), such as to help reduce distortion and residual stress associated with FSW processing.

The configuration shown in FIG. 2B shows a first base structure 202 being joined to plates 212A through 212N. A second base structure can also be joined to the plates 212A through 212N, such as on an opposite side of the plates 212A through 212N, either contemporaneous with a first FSW operation or as a separate operation. As mentioned elsewhere herein, contemporaneous welding operations using separate tools and opposing forging forces can help to neutralize such forces (and corresponding structural distortion or backing fixturing). Contemporaneous formation of multiple welds can also provide efficiencies in terms of throughput (e.g., shortening a material processing duration by performing operations in parallel).

As mentioned above, the configuration shown in FIG. 2A and FIG. 2B can represent a linear mock-up of a portion of a reactor core fuel assembly. For example, the High Flux Isotope Reactor (HFIR) core (Oak Ridge National Laboratory), uses a reactor core including aluminum-clad fuel plates that are joined with 6061 aluminum alloy annular tubes (where such tubes are referred to as side plates). Assembly of the fuel plates inside the side plates is currently done using gas metal arc welding (GMAW), a form of liquid-phase fusion-based welding. The welding process for creating these core assemblies is generally tightly constrained in terms of mechanical requirements. For example, part deflection during the fabrication could damage other portions of the core of the reactor.

The GMAW process that was qualified for this application in the early 1960s is a liquid state process that can induce residual stresses and thermal gradients that can deflect the core geometry, resulting in inadequate welding, significant reworking of the assemblies, or nonconformance reporting. An alternative joining method such as shown and described herein can lower the heat input to the assembly, such as improving conformity with mechanical requirements, reducing deflection, or otherwise improving assembly quality while also potentially reducing cost or processing complexity versus GMAW. The techniques shown and described in this document may also be applicable to fabrication of fuel assemblies for other similar reactor configurations, such as FRM-II (Technical University of Munich), or RHF (Institut Laue-Langevin). For example, existing FRM-II fuel elements may be fabricated using an e-beam welding approach, and the techniques described herein could replace some or all e-beam welding operations.

The mock-up configuration shown schematically in FIG. 2A and FIG. 2B was evaluated experimentally. A series of slots were machined into a 0.25 in. (6.35 mm) thick 6061-T6 plate and one hundred surrogate fuel elements (e.g., plates) made of 0.05 in. (1.27 mm) thick 6061-T6 sheets were lap welded into the parent plate using friction stir welding where the tool was applied to a face of the base “parent” plate from a surface opposite the fuel element. This process simulated fuel plates being attached to the side plates, but in this simplified approach, the plates were attached in a linear configuration. Samples of the thin plates were pulled out of their slots and found to have pull strength exceeding an HFIR structural requirement of at least 100 lbs. pull force. The mock-up material used for this demonstration was AA6061-T6 aluminum. The side plate material used for both the linear and pipe welding demonstrations described in this document was nominally 0.25 in. (6.35 mm) thick, and 0.05 in. (1.27 mm) thick AA6061-T6 was used as mock fuel for the linear joining demonstration. The pipe welding demonstrations were performed on two hollow pipes. First with a 5.5 in. outer diameter (OD) and 0.25 in. (6.35 mm) wall thickness and second with an 8 in. OD and 0.5 in. (12.7 mm) wall thickness.

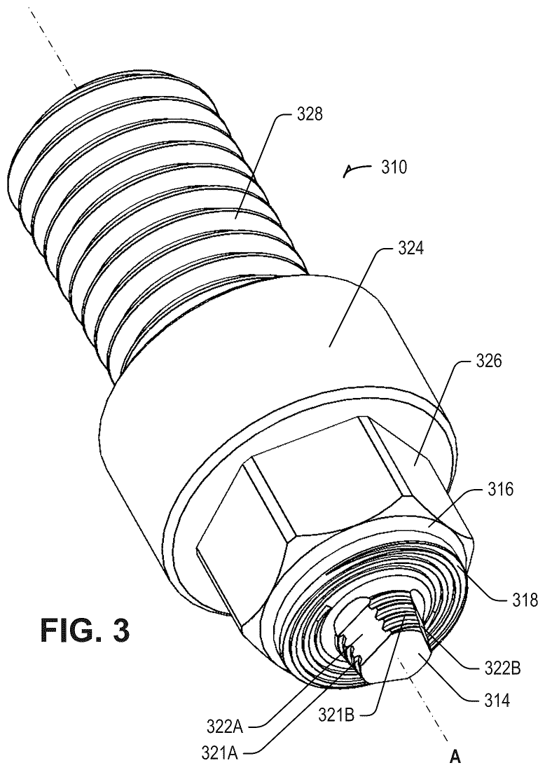

FIG. 3 shows a view of an illustrative example comprising a tool 310 that can be used to perform a friction stir welding (FSW) operation. The tool can include a shank such as having a threaded region 328 for engagement by a spindle. A collar 324 can be included, and a hexagonal head 326 can be included such as to facilitate installation and torquing of the threaded region 328 in a spindle assembly. The configuration shown in FIG. 3 is illustrative, and other configurations can be used for securing the tool 310 to a spindle. A body of the tool 310 can device a face that is generally perpendicular to a longitudinal axis, A, of the tool 310. The face can include or define a shoulder 316, such as having a region extending inward along the face toward a center of the face from an edge of the tool 310 toward an edge or a start of a scrolled feature 318 (e.g., comprising one or more recesses or protrusions). For example, the scrolled feature 318 can include at least one spiral feature defining a channel, such as to direct material toward a center of the face (and correspondingly, a centerline of the weld) in response to rotation of the tool 310.

A pin 314 can protrude from the face, such as having two or more flat regions 322A and 322B on an outer diameter of the pin. The pin 314 can include one or more sets of ridges or grooves extending at least partially circumferentially around the pin such as shown in the grooved region 321A and the grooved region 321B. As discussed below, the grooves can be oriented helically to urge plasticized material toward a root of a welded joint being formed by the tool 310.

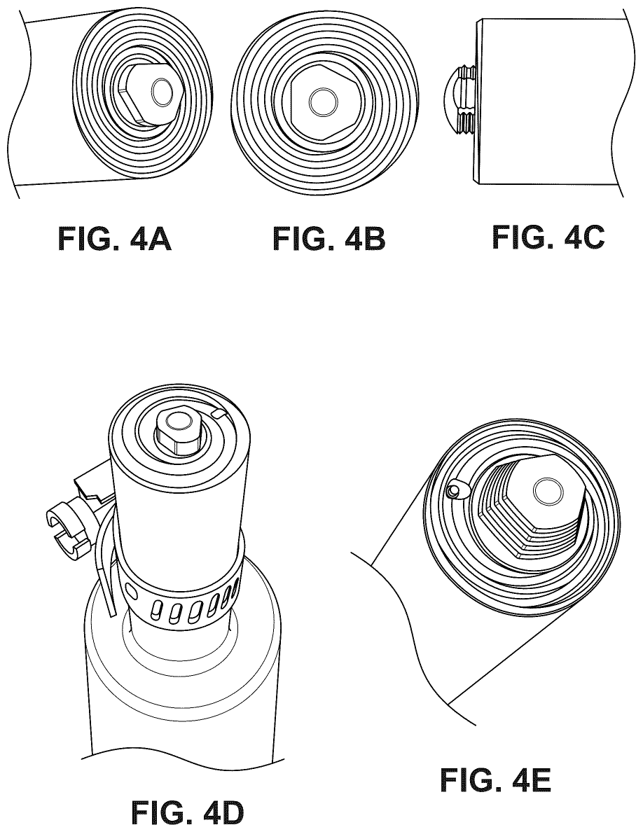

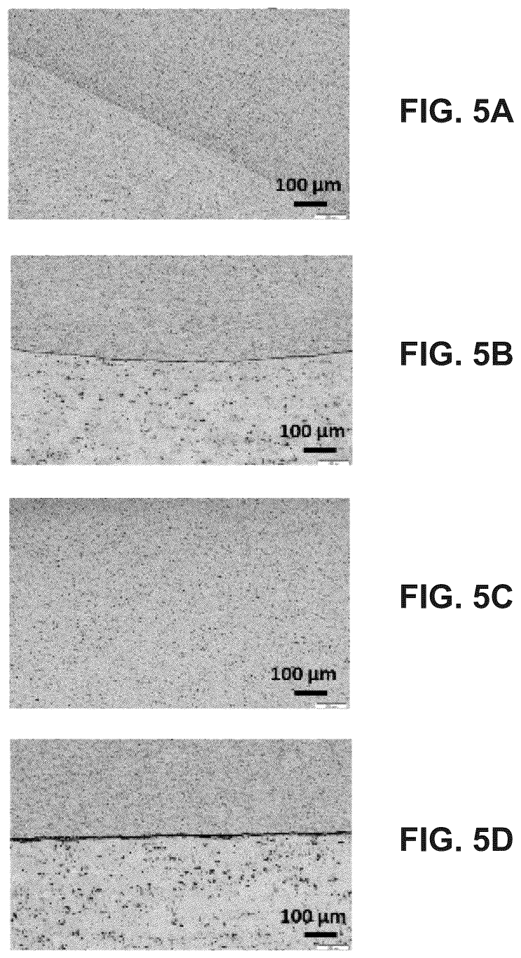

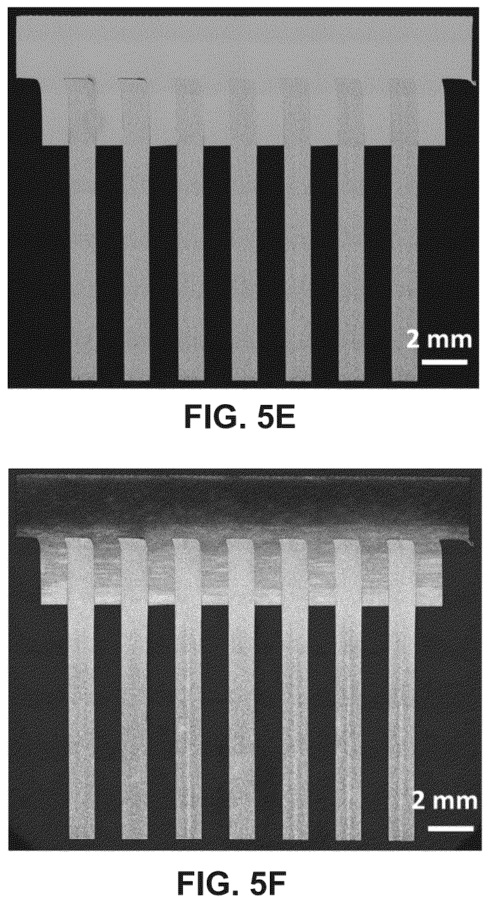

FIG. 4A, FIG. 4B, and FIG. 4C illustrate generally different views of another illustrative example comprising a tool that can be used to perform a friction stir welding (FSW) operation. The views shown in FIG. 4A, FIG. 4B, and FIG. 4C correspond to a tool comprising an 0.63 in. (16 mm) overall shoulder diameter (including the spirally-shaped scroll feature) and an 0.134 in. (3.4 mm) long pin used to make linear FSW runs to join a mock side plate to a mock fuel plate for the experimental data described herein. The spirally shaped scroll features can have a square or rectangular cross-sectional profile, and the tool can include more than one scroll (e.g., there can be more than one spiral “start” corresponding to separate spiral structures). For example, as shown in FIG. 4A through FIG. 4E, the spirally shaped scroll features are double-scrolled and are concave (e.g., extending slightly inward into the face along the axial direction as the spiral extends toward the pin at the center of the face of the tool). The pin length of FIG. 4A, FIG. 4B, and FIG. 4C was specified based on suppressing distortion to a mock fuel plate while still forming a joint between the mock fuel plate and a base structure comprising a mock side plate, such as shown schematically in FIG. 2A and FIG. 2B discussed above, and the cross-sectional views of samples discussed below in relation to FIG. 5A through FIG. 5F.

FIG. 4D and FIG. 4E show further illustrative examples comprising tool that can be used to perform a friction stir welding (FSW) operation, with FIG. 4D comprising a tool comprising an 0.50 in. (12.7 mm) shoulder diameter and 0.079 in. (2 mm) long pin used to make circumferential welds in 5.5 in. pipe for the experimentally-obtained data described herein, and FIG. 4E comprising a tool with an 0.50 in. (12.7 mm) shoulder diameter and an and 0.2 in. (5.2 mm) long pin used to make circumferential welds in 8 in. pipe for the experimentally-obtained data described herein.

Illustrative examples of tools, including those used for experimental evaluation in this document, were made from MP159® (Carpenter Technology), as shown in FIG. 3, and H13 tool steel (FIG. 4A through FIG. 4E), for use in forming welded joints in aluminum structures. For example, as shown in FIG. 3, and FIG. 4A through FIG. 4E, the tool pin that encourages material flow towards the weld root. In these illustrative examples, three flats spaced equally around the pin allow for better material flow around the pin. In these examples, there is a 10° taper in the tool pin (e.g., the pin is wider at the base near a face of the tool and tapers to a narrower diameter or width toward a tip of the pin distal to the face). A distal tip of the pin can be radiused, as shown herein.

A tool temperature can be logged during welding operations, such as using a thermocouple attached to the FSW tool at or near the shoulder region. As discussed below in relation to the compact spindle assembly, the thermocouple can be monitored using a wireless transmitter. Tool forces can be measured by using one or more integrated strain gauges. An illustrative example of an acceptable range of shoulder temperatures for the processing described herein (for processing aluminum structures) is about 400C to about 500C at a welding traversal speed of about 0.25 m/min to about 1 m/min, and a corresponding rotational velocity of the tool of about 600 revolutions-per-minute (RPM) to about 1500 RPM.

FIG. 5A, FIG. 5B, FIG. 5C, and FIG. 5D show illustrative examples of views of transverse cross-sectioned structures comprising friction stir welded joints using a technique as described in FIG. 1A, FIG. 1B, FIG. 1C, FIG. 2A, and FIG. 2B. FIG. 5E and FIG. 5F show illustrative examples of views of longitudinal cross-sectioned structures. FIG. 5A through FIG. 5F show different views of portions of friction stir welded joints using a technique as described in FIG. 1A, FIG. 1B, FIG. 1C, FIG. 2A, and FIG. 2B.

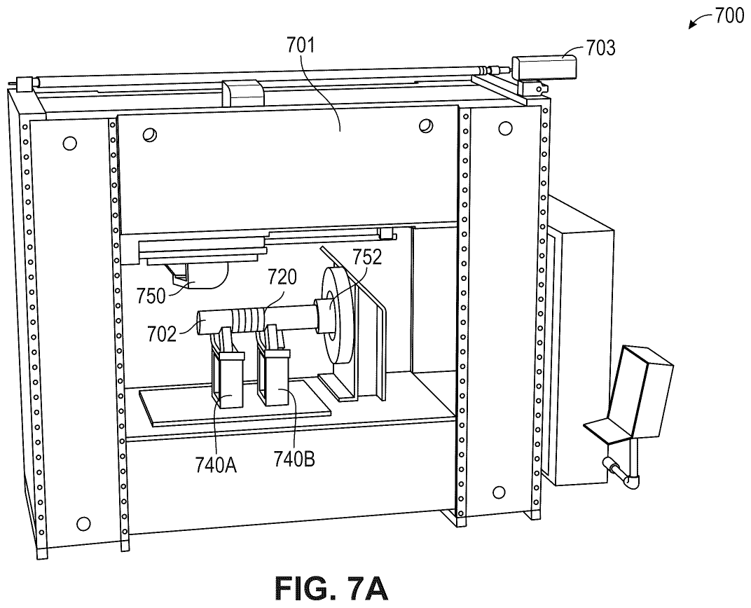

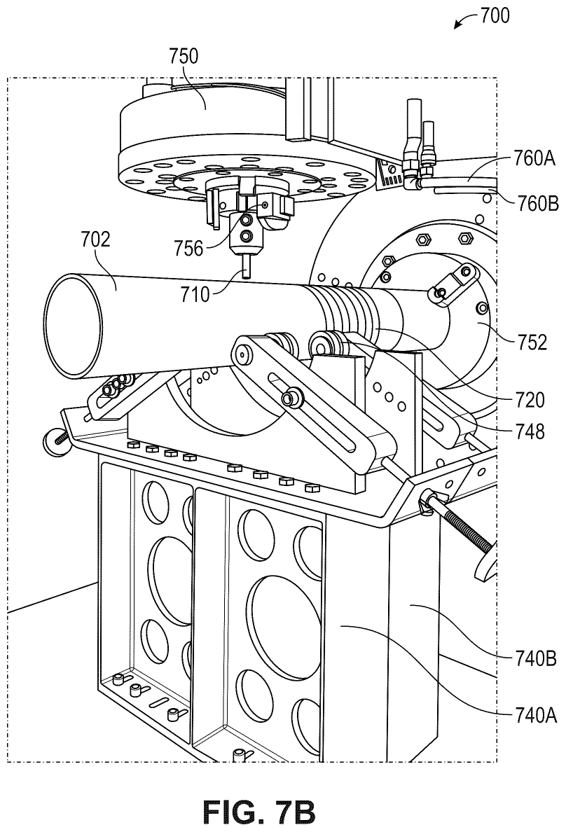

The tool configuration shown in the views of FIG. 4A. FIG. 4B, and FIG. 4C was used to fabricate the structures shown in FIG. 5A and FIG. 5B. As mentioned above, as a proof-of-concept, side plate to fuel plate joining was modeled using a linear demonstration. Materials included a base structure (e.g., “side plate”) comprising an 0.25 in. thick AA6061 aluminum sheet welded to mock fuel plates in a configuration that simulated a portion of an HFIR core arrangement. For this experiment, one hundred slots with 0.12 in. depth and, 0.05 in. width were machined on the underside of the side plate at a gap distance of 0.05 in., as shown schematically above in FIG. 2A. The fuel plates were modeled by 3 in. by 3 in. wide 0.05 in.-thick 6061 sheets were slip fit into the slots to simulate the HFIR fuel. The opposite ends of the mock fuel plates were slip fitted to another side plate similarly machined that served as a backing as shown illustratively in FIG. 2B. This setup was clamped to a bed of an FSW system (e.g., as shown below in FIG. 7A and FIG. 7B), and a welding run was made. A plunge depth is similar to that shown schematically in FIG. 2A, where the plunge depth corresponds to about or exactly the same as a nominal pin length (e.g., plunging the pin into the base structure to a depth corresponding to a length of a protrusion of the pin).

Referring to FIG. 5A through FIG. 5D transverse cross-sections of linear side plate to mock fuel plate FSW joint were cut, polished, and imaged. The weld structure shows a basin shape indicative a nugget region, comprising recrystallized and refined grains (see., e.g., FIG. 5C showing a close-up view of this region). Under the weld nugget, the side plate is well bonded to the mock fuel plate as evidenced by the optical images as shown in FIG. 5A, FIG. 5B, and FIG. 5D. The dark line demarking the side plate and fuel plate is an oxide layer, as shown in FIG. 5D. This can be observed when thorough mixing has not occurred between two adjacent Al layers. In this experimental evaluation, a pin length was used such that minimal engagement into the fuel plate occurred, and accordingly, vertical mixing between the side plate and mock fuel plate has not occurred, though there is still bonding occurring as evidenced by pull testing.

Referring to FIG. 5E and FIG. 5F, cross-sections (both etched as in FIG. 5F and unetched as in FIG. 5E) in a longitudinal direction also show bonding. Three samples (side plate 0.5 in. thick and 5 in. wide) were cut using electron discharge machining from the welded assembly for mechanical pull testing, where each side plate encompassed one mock fuel plate. Finger clamps were used to constrain the side plate on either side while the mock fuel end was gripped by test grip/jaws. Upon mechanical testing of three samples, fracture loads of 185, 123, and 163 lbf were measured. For all three cases, fracture was interfacial. This pull strength comfortably exceeded the minimum pull strength (100 lbf) guideline provided for an HFIR fuel-plate-to-side-plate joint application.

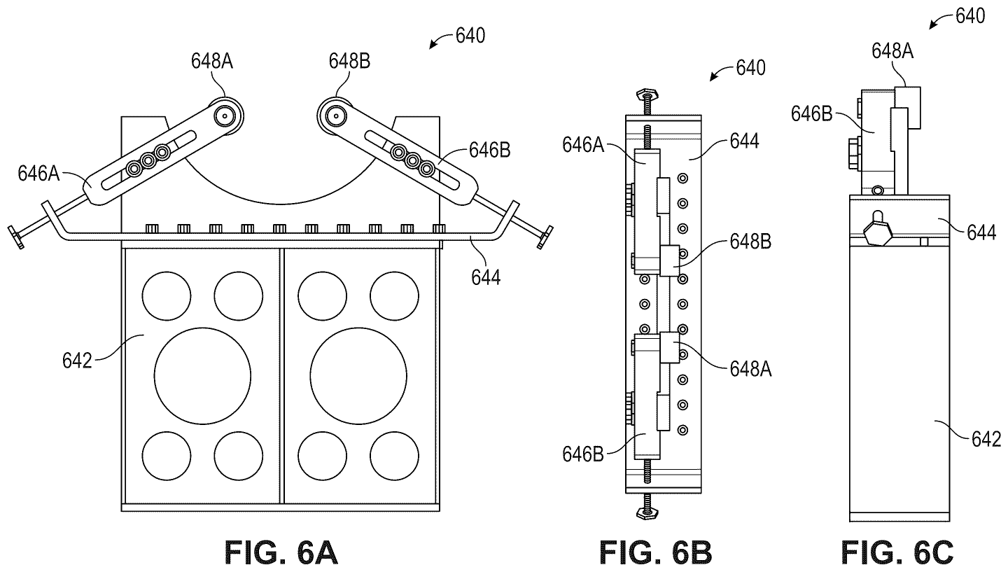

Because the side plates used for the HFIR application are tubular, and there are many other useful applications involving FSW applied to tubular structures, fixturing was developed to accommodate tubular structures. FIG. 6A, FIG. 6B, and FIG. 6C show different views (front, top, and side, respectively) of an illustrative example comprising a rest support 640 that can be used to support a workpiece on which a friction stir welding (FSW) is being performed. Generally, a stable backing is provided during FSW processing to react to forging/Z force, along with some degree of lateral or planar force.

The configuration shown for the rest support 640 in FIG. 6A, FIG. 6B, and FIG. 6C comprises a base 642 that can be bolted to a bed or base of an FSW system as shown in FIG. 7A and FIG. 7B. Referring to FIG. 6A, FIG. 6B, and FIG. 6C, the rest support 640 can be bolted to or can include a rest 644 comprising arms 646A and 646B. The arms 646A and 646B can include or be coupled to rollers 648A and 648B. The arms 646A and 646B can be adjustable, such as using threaded rods or other approaches, such as to accommodate a range of different sizes of tubular structures. For example, in the example of FIG. 6A, FIG. 6B, and FIG. 6C, tubular structures such as pipe up to 9 in. OD can be received, though this is merely an illustrative example.

FIG. 7A and FIG. 7B show different views of a friction stir welding (FSW) system 700 that can be used to perform FSW operations as shown a described elsewhere herein. For the experimental evaluation described in this document, FSW operations were performed using an MTI/TTI LS 2-2.5 (7004) Series Friction Stir welder at the Applied Engineering Laboratory at Pacific Northwest National Laboratory. FIG. 7A and FIG. 7B show a representation of the FSW system 700, including two steady rests 740A and 740B having a configuration as shown in FIG. 6A, FIG. 6B, and FIG. 6C. Referring to FIG. 7A, the system 700 can include or use a gantry 701, such as having a motor 703 driving a carriage comprising or supporting a spindle 750. A rotary turntable 752 can be used to secure and rotate a work piece such as a tubular structure 702 (e.g., a section of pipe), and the spindle 750 can establish a forging force and rotation of a tool relative to the tubular structure 702 to form a weld 720.

Referring to FIG. 7B, the system 700 can include or use steady rests 740A and 740B arranged such that their rollers (e.g., roller 748) are spaced apart from each other by a specified distance along a long axis of the work piece (e.g., tubular structure 702). This spacing can be determined in part to facilitate welding over a wider span (in the axial or long axis of the of tubular structure 702) without having to change the setup. In this manner, an FSW operation performed by the tool 710 actuated by the spindle 750 can occur at an axial location offset from the rollers of steady rests 740A and 740B (as shown in FIG. 7B). A degree of such offset can impact how much (if any) distortion of the tubular structure 702 occurs, because such distortion generally increases as an offset increases.

As an illustrative example, and as shown in FIG. 7A and FIG. 7B, the system 700 can include a rotary turntable 752. Referring to FIG. 7B, the rotary turntable 752 can be a 33 in. diameter assembly (model no. MTI011752) with an adjustable three-jaw chuck, where the turntable 752 comprises electrical servo-controls integrated with the rest of the system 700 control (e.g., as an illustration, such servo-controls can be supported by the LS2 machine mentioned above). The system 700 shown in FIG. 7B, used for the experimental evaluation described herein, has an X travel range of 98 in., a Y travel range of 3.9 in. (e.g., in the plane of the bed) and a Z travel range of 11 in., corresponding to direction normal to the bed. The welding traversal speed is limited to 2.9 m/min in the X and Y directions and 1 m/min in the Z direction, with a tilt angle of plus-or-minus 5 degrees along the X direction. The rotational speed of the turntable 752 is limited to no more than 1950 RPM.

The control software for the system 700 can include programmability, such as supporting closed-loop control based on parameters such as temperature (e.g., measured and transmitted using a wireless transmitter 756) or power dissipation. Parameters can be selected manually or automatically such as taking into consideration an alloy of the work piece being processed. Illustrative examples of parameters that can be monitored or controlled include tool temperature; tool forces in the X, Y or Z directions (or combinations thereof); power dissipation (such as associated with spindle rotation); or torque. For example, a welding operation can include monitoring a temperature at or near an interface between the tool and the base structure, and in response, using the monitored temperature to control at least one of the forging force, rotational velocity, translational velocity, or tool orientation.

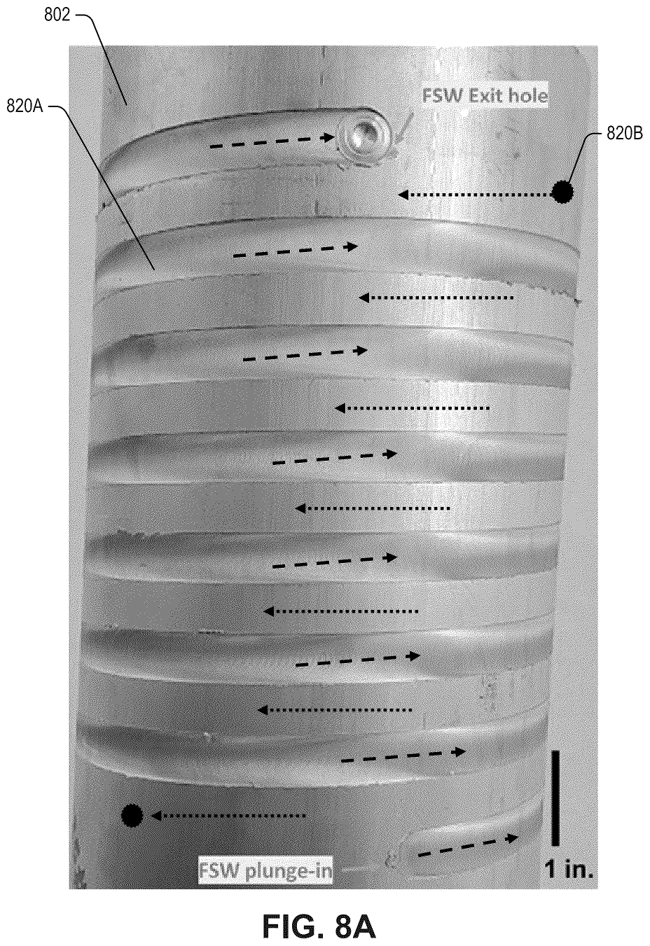

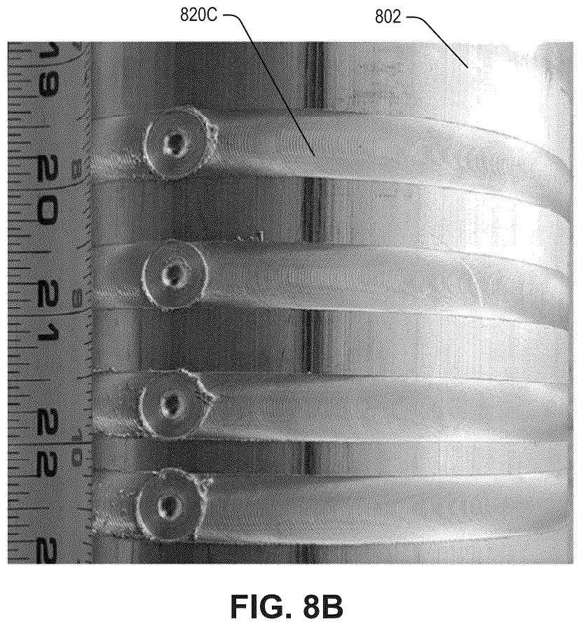

While the examples of FIG. 7A and FIG. 7B show only a single spindle and corresponding tool, the techniques described herein can include or use a second tool, such as with a second forging force and corresponding rotation. The second tool could contact the work piece (e.g., a flat or tubular base structure) in a location to oppose the forging force established at the first tool, to plastically deform and mix, in the solid phase, material comprising the base structure (and, similar to other examples, optionally, material comprising another plate to form another joint between base structure and another plate). In this manner, multiple joints can be formed contemporaneously for process efficiency. This approach may also allow the opposing second tool and corresponding forging force to neutralize the first forging force. In yet another example, such as discussed below in relation to FIG. 8A, a second joint can be formed adjacent to a first joint using an opposite travel direction (e.g., spirally opposite as shown in FIG. 8A), such as to help neutralize residual stress.

As an illustration of forming welded joints in tubular structures, circumferential friction stir welding was demonstrated on two hollow AA6061-T6 pipe sizes: 0.25 in. wall thickness pipe with a 5.5 in. outer diameter (OD); and 0.50 in. wall thickness pipe with an 8 in. OD, using an FSW system 700 as shown in FIG. 7A and FIG. 7B. Two types of welding were performed: a spiral circumferential weld path and circular circumferential weld path. Experimental observations on processed pipes show that overall measured distortion in the 8 in. OD pipe was 0.0004 in. on the inner diameter (ID).

For experimental evaluation, the pipe was loaded on three-jaw chuck (of the turntable 752 as shown in FIG. 7B) and centered using a dial gage. Care was taken to make sure that the pipe was level so that the Z position in the X direction remained consistent during multiple circular and spiral FSW trials. For initial trials in the 5.5 in. OD pipe, an FSW tool having a pin length=0.079 in. (2.0 mm), shoulder diameter=0.5 in. (12.7 mm) with scrolled shoulder, threads on the pin and three flats on the pin was used. This configuration of FSW can be used butt joining in other applications and corresponds to the tool shown in FIG. 4D.

Welding trials were performed in a linear configuration without a backing plate to mimic unsupported pipe welding. This was done by using two narrow steel bars to support the edges of the plate. After several runs, welding parameters that resulted in reduced plate distortion and defect free welds were selected for the pipe welding trials, which then were performed using the identified parameters. Defects such as flash or a lack of consolidation can occur when a tool plunge depth or power was either inadequate or excessive. Adjustment can be performed to Z position, tool rotational speed, and tilt angle, to obtain a satisfactory weld bead. After initial establish of parameters, an 8 in. long spiral weld was executed using the Z force and temperature control modes using an FSW tool shown in FIG. 4E. A shoulder temperature set point of 460° C. was maintained by modulating spindle torque while the Z force was set at 6 kN at a welding speed (circumferential speed) of 0.5 m/min.

FIG. 8A illustrates generally a tubular structure 802 on which a friction stir welding (FSW) tool (e.g., using a system 700 as shown in FIG. 7A and FIG. 7B) has been used to form a weld 820A along a spiral weld path. The spiral weld 820A path comprises an 8-foot-long continuous spiral on an outer face of a 5.5” OD pipe. A location and tool plunge-in and tool extraction (lift off or “exit hole”) are also shown. A pitch (e.g., a lateral spacing between centers of adjacent turns of the spiral) is 1 in. in this illustrative example. The present inventors have also recognized, that, using a similar spiral weld path, a second welding pass can be initiated tracking in a direction opposite the spiral weld 820A. For example, a second spiral weld 820B path can be initiated at a location near the exit of the first spiral weld 820A, such as offset 90 to 270 degrees along a circumference of the tubular structure 802. The second spiral weld 820B can be formed in the gap between adjacent turns of the first spiral weld 820A as shown by the finely dashed arrows (and where a direction of the first spiral weld 820A is shown by the coarsely-dashed arrows). An end to the second spiral welding pass can be located at a location offset to the plunge-in location corresponding to the first spiral weld 820A, such as shown in the lower left of FIG. 8A. For example, such offset can be 90 to 270 degrees along the circumference of the tubular structure 802. Use of a second, opposing-direction, spiral weld 820B can help to suppress or relieve residual stress associated with the first spiral weld 802A.

FIG. 8B illustrates generally a tubular structure 802 on which a friction stir welding (FSW) tool (e.g., using a system 700 as shown in FIG. 7A and FIG. 7B) has been used to form respective circumferential welds such as comprising a representative weld 820C. In general, the examples of FIG. 8A and FIG. 8B show that an FSW processing approach can be suitable for through-wall welding on tubular structures, such as to join a plate extending from an opposite wall of the tubular structure 820 inward, similar to the linear mock-up configurations discussed above, but having a circular outer profile for the base structure. The examples of FIG. 8A and FIG. 8B used 5.5 in. OD pipe. Similarly, a spiral FSW was performed in 8 in. OD pipe using the system of FIG. 7A and FIG. 7B and a slightly different tool as discussed elsewhere herein. In an example, a continuous spiral weld was performed over a longitudinal pipe length of 12 in. resulting in a weld path length of 25 ft.

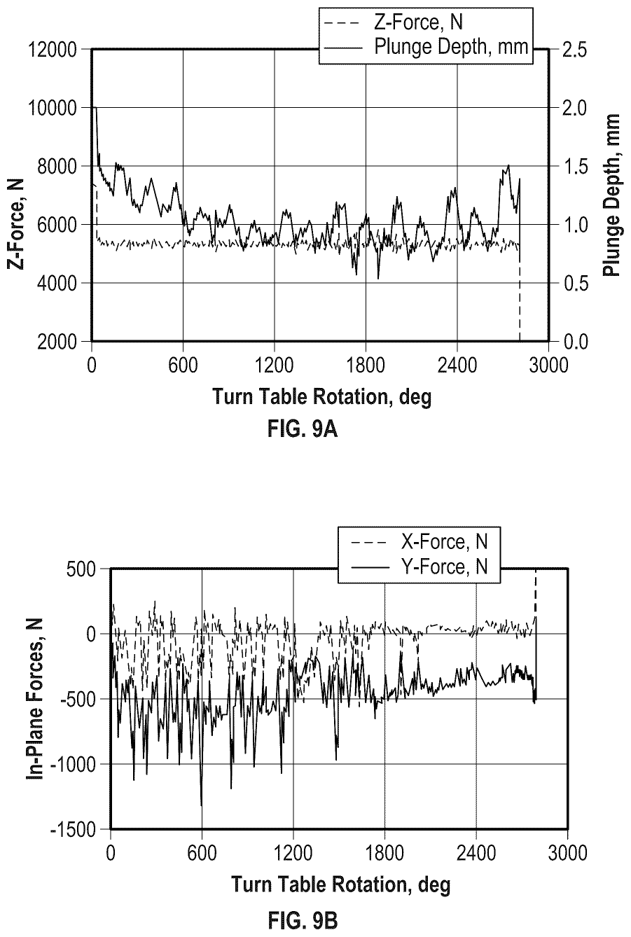

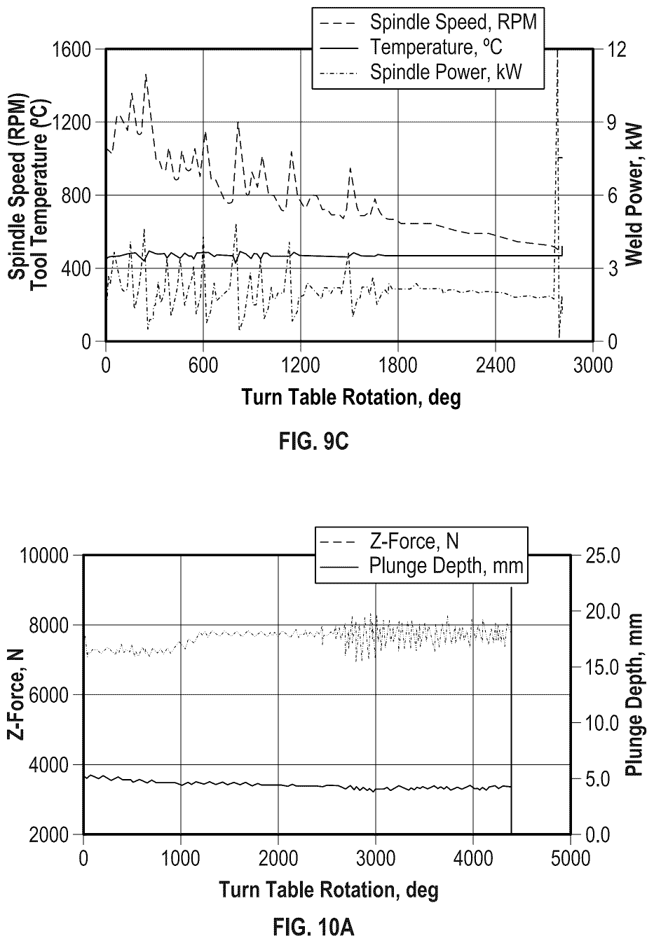

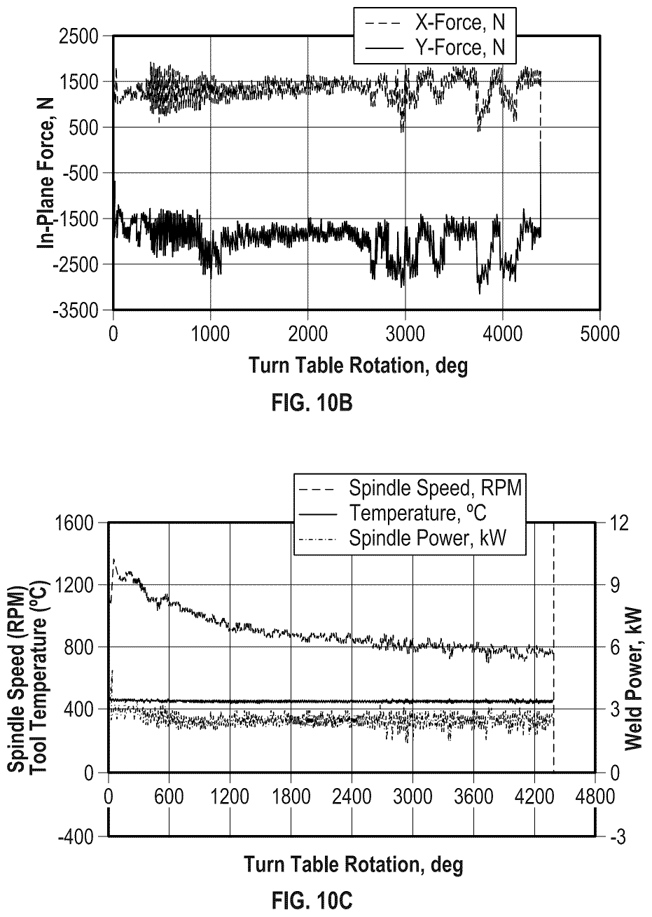

FIG. 9A, FIG. 9B, and FIG. 9C illustrate respective parameters used for forming a weld on 5.5 in. OD pipe and FIG. 10A, FIG. 10B, and FIG. 10C illustrate respective parameters used for forming a weld on 8 in. OD pipe. In particular, FIG. 9A, FIG. 9B, and FIG. 9C show the evolution of tool forces, power dissipation, tool temperature, and rotational speed during an FSW operation on 5.5 in. OD pipe. FIG. 10A, FIG. 10B, and FIG. 10C show similar data obtained during a spiral welding run on 8-in. OD pipe. The Z force (e.g., forging force or plunge force) used for the 5.5 in. OD pipe was 1200 lbf (5.4 kN), and the corresponding force used for 8 in. pipe was 1750 lbf (7.8 kN). The plots shown in FIG. 10A, FIG. 10B, and FIG. 10C indicate that for this experimental evaluation, tool forces in all axes were more stable in welding 8 in. OD pipe as compared to 5.5 in. OD pipe. A closed-loop mode was used where other parameters were modulated to provide a stable specified tool shoulder temperature as welding progressed. For example, RPM values decreased as welding progressed, to maintain a specified thermocouple indication of 460 degrees C., from 1150 RPM to 800 RPM. This decrease may be attributable to gradual heating of the pipe structure by the FSW tool. Generally, the 8 in. OD pipe exhibited less distortion as compared to the 5 in. OD pipe, indicating that such distortion may be further reduced using similar process parameters if extended to even larger outer diameters.

Characterization of the demonstration pipe welds mentioned above included optical metallography and manual measurements of pipe distortion after welding. For 5.5 in. OD circular welds, seven transverse cross-sections were polished and etched. Weld nuggets consistent with the linear FSW examples discussed above were observed. A slight localized deformation under the FSW tool was observed on the ID of the pipe in the 5.5 in. pipe welds (exhibiting maximum distortion of about 0.02 in. (0.5 mm)). The highest distortion was observed underneath the FSW tool plunge-in location where the tool dwells prior to traversing. In spiral pipe welding demonstrations, the average ID deviation over a length of a 7 in. of spiral weld was only 0.0083 in. Because spiral welding results in lower overall heat input in the localized area compared to a perfectly circular circumferential weld, reduced ID distortion can be expected in spiral welding applications versus circular for the same outer pipe diameter.

In the demonstration of the 8 in. OD pipe with 0.5 in. wall thickness, even lower distortion was observed after welding versus the 5.5 in. demonstration. Over a length of a 12 in. long spiral weld, the average ID distortion measured was 0.004 in., and it was visually apparent that the distortion was lessened in the 8 in. demonstration. However, direct comparison between the two pipe sizes discussed herein may be difficult. The FSW tool pin lengths used for the two pipe diameters were different. Also, a wall thickness of the 5 in. OD pipe was 0.25 in. add the wall thickness of the 8 in. pipe was 0.5 in.

An FSW pin length of 2 mm was used for 5 in. OD and for the 8 in. OD pipe, the FSW pin length was 5.2 mm. Thus, the FSW pin engagement into the pipe was 31% of thickness on 5.5 in. pipe and it was 40% for the 8 in. pipe. Because a larger material volume is being plasticized in the case of 8 in. OD pipe it is possible that greater heat input and hence energy was expended for welding the 8 in. OD pipe. As an illustrative example, an average power monitored for spiral welding for 5.5 in. OD pipe was 1.7 kilowatts (kW), and for 8 in. OD pipe, the corresponding power dissipation was 2.8 kW. The 8 in. OD pipe has a significantly larger overall volume. Without being bound by theory, it is theorized that an overall pipe distortion is at least in part a function of total thermal mass.

Demonstration of linear mock-up and tubular welding processes using FSW indicate that FSW is a candidate for fabrication of linear or cylindrical structures having plates extending from or between other structures. Applications for such FSW processing include fabrication of heat exchanges, tubular structures such as pipes, or fuel assemblies such as for nuclear reactor applications. For example, as discussed elsewhere herein, the High Flux Isotope Reactor (HFIR) core includes aluminum-clad fuel plates that are joined to 6061 aluminum annular tubes (that can be referred to as side plates).

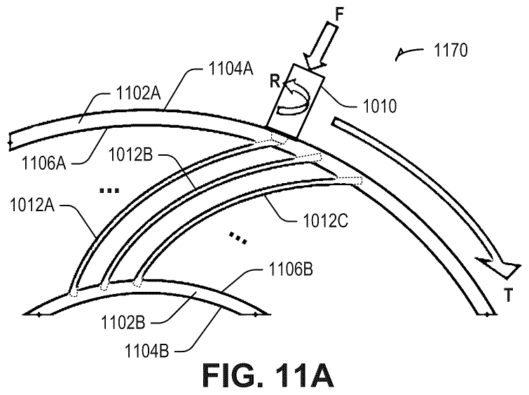

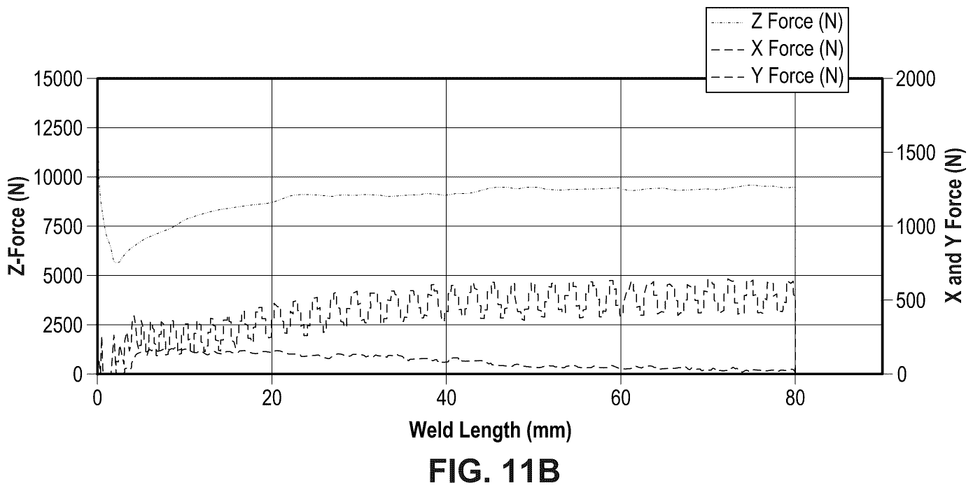

To aid visualization of this sort of structure, FIG. 11A illustrates generally a configuration for a portion of an illustrative example comprising a nuclear reactor core fuel assembly 1170, such as for use with the High Flux Isotope Reactor (HFIR), including cylindrical side plates (e.g., an outer side plate 1102A and inner side plate 1102B), and involute fuel plates 1012A, 1012B, and 1012C extending therebetween. Fabrication of the core assembly 1170 is a challenging process. For example, HFIR uses a total of 540 involute fuel plates (369 outer plates and 171 inner plates) loaded into two nested cylindrical capsules/cores (referred to as side plates in this report), with each cylindrical capsule having a configuration similar to the portion of the nuclear reactor core fuel assembly 1170 shown in 11A. As discussed elsewhere herein, one approach for fabricating the nuclear reactor core fuel assembly 1170 can include gas metal arc welding (GMAW) by extremely competent fabricators, where the involute fuel plates 1012A, 1012B, and 1012C are assembled into corresponding slots/combed structures as shown and described elsewhere herein. Any fluctuations occurring during the fabrication can damage the reactor core.

Generally, a slot depth for the GMAW approach is about 0.1 in. (2.5 mm). This may not necessarily be ideal for FSW. Generally, one factor influencing selection of an FSW pin length of the tool 1010 is the slot depth. For example, the deeper the slot depth in a first face 1106A opposite a second face 1104A, the shorter the pin used to make effective joints. Generally, a shorter pin length corresponds to a tool 1010 having a smaller diameter shoulder. A reduced diameter shoulder can be used with a correspondingly reduced forging force that might help to reduce overall distortion. However, excessively deep slots also can result in removal of a large amount of material from the side plate 1102A. Such reduction of material may decrease overall stiffness of the tubular structure formed by the outer side plate 1102A (or a combination of the outer side plate 1102A and the inner side plate 1102B). FSW tool configurations that are generally available assume that they will be used for processing of work pieces that are fully supported. In the case of fuel element-to-side plate welding, a rigidity of the backing can be more limited. Accordingly, FSW parameters and tool configurations (e.g., shoulder diameters, pin lengths, and other geometries) can be considered, such as to lower the forging force, F, or vary other parameter such as rotational velocity of tool rotation, R, or traversal forces or velocity (e.g., impacting translation, T, of the tool 1010).

A welding trial with a radially inserted mock fuel plate was performed where the plate was processed using FSW to join it with a 5.5 in. OD pipe. Such radial insertion is similar to joints formed in the linear configuration discussed above with respect to FIG. 1A, FIG. 1B, FIG. 1C, FIG. 2A, and FIG. 2B, where slots are perpendicular to the side plate or other base structure. However, as shown illustratively in FIG. 11A, certain reactor core fuel element configurations such as HFIR, use slots that are not perpendicular. For example, as shown in FIG. 11A, the slots are inclined at 45 degrees, so bonding characteristics may be different.

FIG. 11B illustrates generally forces used for performing a friction stir welding (FSW) operation on a face of a side place comprising an aluminum mock-up of a fuel element as shown in FIG. 2A. A weld crown surface showed no signs of weld defects, corroborated by the characterization discussed above herein. Process forces in the X, Y, and Z directions are shown in FIG. 11B. A fluctuation in the X force is apparent and indicative of respective gaps between the side plates and the base structure. In particular, an air gap in “front” of the fuel plate (in the direction of the traverse of the tool) results in reduced tool force and the Z force increases when the tool is over the fuel plate resulting in periodicity in measured FSW process forces. A plunge depth fluctuation correlating with Z force is believed not to reflect actual fluctuation of the tool with respect to the workpiece. The plunge depth is a calculated from machine deflection, so monitored values are not absolute. However, monitoring parameters such as plunge depth, even if not accurate in an absolute dimensional sense, can still be used to establish process control and to evaluate repeatability of FSW processing.

Referring back to FIG. 11A and relative to other examples discussed in this document, the tool 1010 in FIG. 11A is shown performing through-wall FSW processing from an outward-facing portion of the nuclear reactor core fuel assembly 1170. As shown in FIG. 11A, similar welding operations would be performed on an inward facing second surface 1104B of a second, inner side plate 1102B, to join the respective involute fuel plates 1012A, 1012B, and 1012C to a first surface 1106B of the inner side plate 1102B. Because welding from the “inside out” of the fuel assembly would generally involve placing a spindle in a confined environment within an enclosed structure, the present inventors have also recognized, among other things, that a compact spindle assembly can be used. The compact spindle can support FSW processing similar to the examples discussed above, such as using a system similar to that shown in FIG. 7A and FIG. 7B but including or using a spindle configuration as shown and described below, such as having a right-angle orientation relative to a support arm. The compact spindle can be sized and shaped to perform FSW processing on inward-facing portions of structures, such as for the plate-to-base structure processing described elsewhere herein, or for fabrication of other structures such as tubular seam welding of walls of a tubular structure from within the structure, rather than on an exterior surface (or in addition to welding an exterior surface).

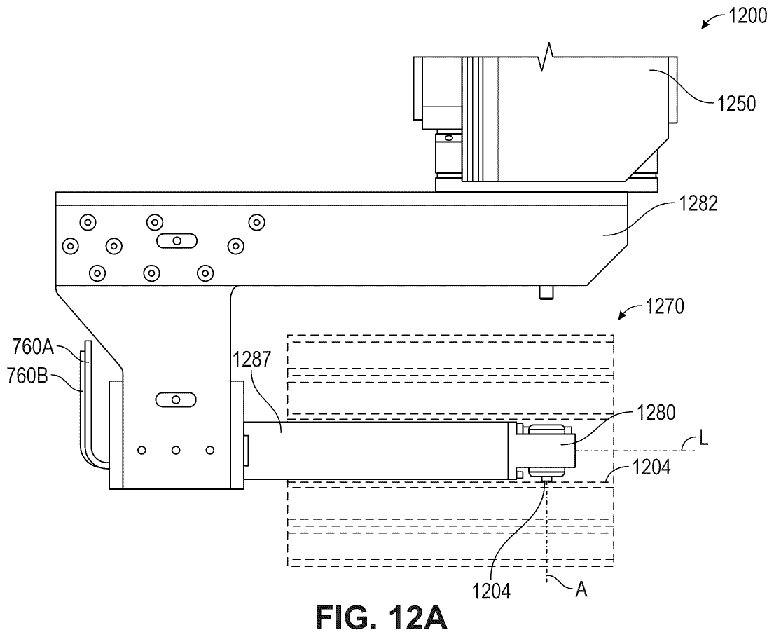

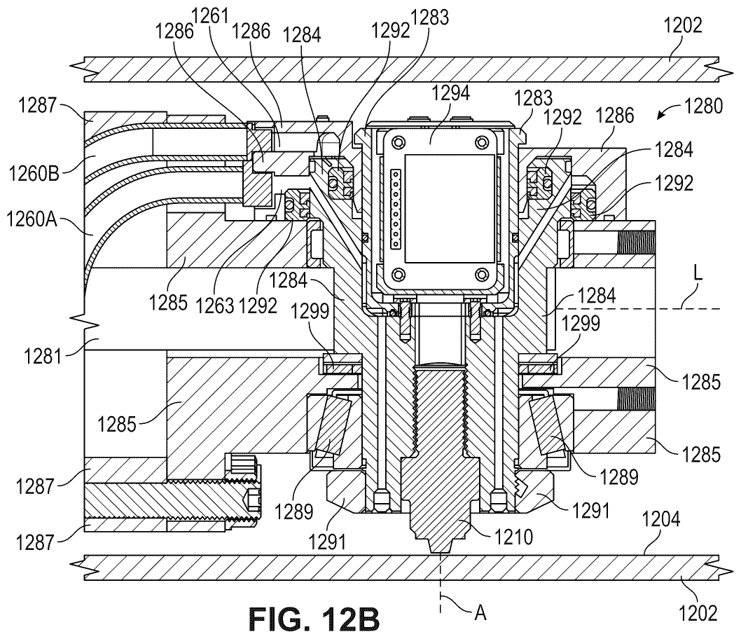

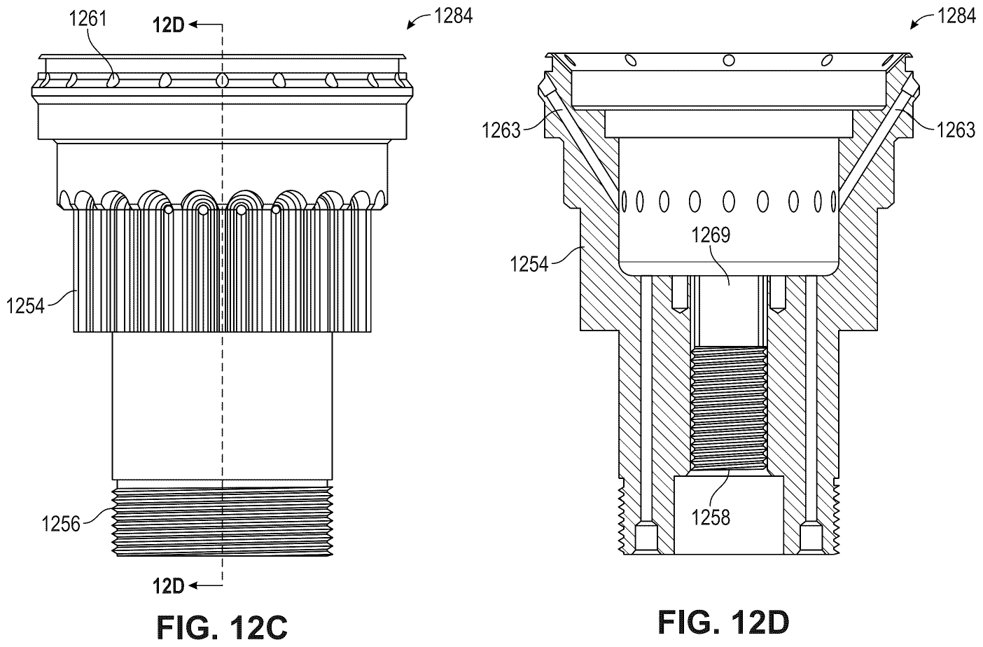

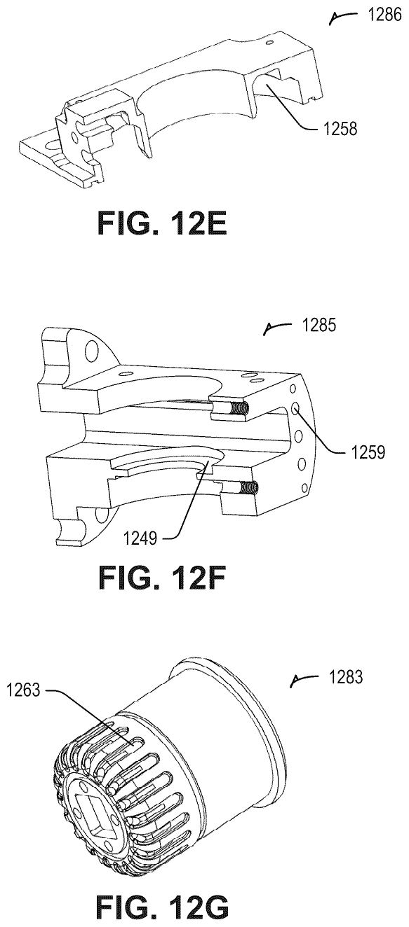

FIG. 12A illustrates generally an example of a system 1200 comprising a compact spindle assembly 1280 and support frame 1282 that can be coupled to a prime mover 1250 (such as an existing FSW machine spindle). An FSW approach using the compact spindle assembly 1280 can be referred to generally as an “Internal Friction Stir Welding (IFSW)” approach, though the compact spindle assembly 1280 need not literally be used only internally within other structures. Use of the compact spindle assembly 1280 can enable high-quality welding in confined spaces where existing approaches are not sufficiently compact. For example, as discussed below in FIG. 12B, the compact spindle assembly 1280 can be instrumented such as providing wirelessly transmitted temperature or other process data (a temperature. a rotational velocity associated with the tool, a rotational position of the tool, a force associated with the tool, or combinations thereof). Other features can include an integrated cooling configuration (e.g., using a coolant loop established by supply and return lines 760A and 760B, respectively) and visual (e.g., digital camera) monitoring of the interface between the tool and the work piece.

As discussed in relation to other FSW processing approaches described in this document, use of the compact spindle assembly 1280 is applicable to various domains such as nuclear fuel components, heat exchangers, oil and gas pipelines, and raw material manufacturing, such as for welded pipe manufacturing. The compact spindle assembly 1280 configuration described below is modular and allows adaptability to different tasks and materials, making it suitable for a variety of component geometries. In the example shown in FIG. 12A, the prime mover 1250 can be an existing large-spindle FSW machine, and the compact spindle assembly 1280 and associated support frame 1282 can be attached to and manipulated by the existing machine, providing compatibility with a broad range of existing equipment. Alternatively, or in addition, the compact spindle assembly 1280 can include a compact electrical or hydraulic drive to rotate a tool or manipulate a position of the spindle assembly 1280.

As shown illustratively in FIG. 12A, the compact spindle assembly 1280 can perform an FSW operation on a face 1204 of a base structure such as a portion of a nuclear reactor core fuel assembly 1270, where the face 1204 points inward. A support arm 1287 can be configured to manipulate and control the compact spindle assembly 1280 from outside the nuclear reactor core fuel assembly 1270. Such an approach involving mechanically manipulating and powering the compact spindle assembly 1280 using a prime mover 1250 located elsewhere is merely illustrative.

FIG. 12B illustrates generally a cross-sectional view of the compact spindle assembly 1280 and associated friction stir welding (FSW) tool 1210, within a tubular structure 1202. The tool 1210 can have a configuration similar to the tool 310 shown in FIG. 3, as an illustrative example, such as coupled to a spindle shaft 1284 using a threaded coupling. The spindle shaft 1284 can be rotated such as using a drive belt 1281 (e.g., driven by a prime mover and associated belt and drive shift linkage, through the support arm 1287 and support frame mentioned above). The spindle shaft 1284 can be supported by a spindle housing 1285. The spindle shaft 1284 can rotate freely, with axial and radial process forces handled in part by a roller bearing 1289 seated in the spindle housing 1285. The spindle housing 1285 can also provide a seat for an axial bearing 1299. Pre-load of the bearing structures can be assisted by a pre-load nut 1291 arranged to engage outside threads on the spindle shaft 1284. The spindle shaft 1284 can form a rotary union with spindle housing 1285 and a static portion 1286. The static portion can also provide or define coolant passages 1261 and 1263 aligned with corresponding portions of the spindle shaft 1284 to provide a rotary coolant circulation loop. The coolant can be supplied and returned using coolant supply and return lines 1260A and 1260B). Fluid containment and isolation can be facilitated by seals 1292 at a union between the spindle shaft 1284 and the static portion 1286.

The spindle shaft 1284 can define a hollow region, such as to support a cup 1283. The cup 1283 can serve multiple purposes, such as housing a wireless data transmitter 1294, such as to transmit process data such as temperature. As shown and described below, the cup 1283 can also provide coolant passages to circulate coolant to a region near the tool 1210, which preserves material of the spindle shaft 1284 in the pulley region driven by the belt 1281. As shown in FIG. 12B, the compact spindle assembly 1280 can apply a forging force in an axial direction, A, of the tool 1210, such as perpendicular (or nearly perpendicular) to a longitudinal axis, L, of the support arm 1287 and corresponding elongate tubular structure 1202. In this manner, FSW processing can be performed on an inward-facing portion of a tubular structure 1202 or within another enclosed or otherwise confined space, such as where interference would otherwise occur between a non-compact spindle or FSW machine and the workpiece. For example, the techniques described herein, referring to “tubular” structures need not be restricted to strictly circular cross-sectional profiles, or to entirely enclosed cross-sectional profiles. The forging force in the axial direction, A, need not be developed locally by the compact spindle assembly 1280. For example, the support arm 1287 can rigidly transmit forging and translational forces to the spindle assembly 1280, in addition to housing the drive belt 1281.

A surface opposite the pre-load nut 1291 and tool 1210, such as above the cup 1283 in the view of FIG. 12B need not be flat or unused. For example, a second tool could be included facing an opposite direction along the axial direction, A, or a movable anvil could be included, such as to neutralize a reaction on the compact spindle assembly 1280 to the forging force. Use of a second tool could enable contemporaneous FSW processing on two portions of the tubular structure 1202.

FIG. 12C and FIG. 12D illustrate generally respective views of a spindle shaft 1284 of the compact spindle assembly, with a side view shown in FIG. 12C and a corresponding section view shown in FIG. 12D to illustrate coolant passages and internal configuration. Referring to FIG. 12C, a splined pulley 1254 can be included as a portion of the spindle shaft 1284, such as to receive force imparted by a belt (e.g., a timing belt having transverse ribs or grooves to positively engage splines on the pulley 1254 to impart rotational force). The spindle shaft 1284 can include ports to coolant passages 1261 defined by the spindle shaft 1284, such as to receive or provide coolant circulated through a region at or near the FSW tool held by the spindle shaft 1284. An outer thread 1256 can be included to receive a preload nut to assist in securing the spindle shaft 1284 to a housing along with providing at least one of axial bearing or radial bearing preload. Referring to FIG. 12D, coolant passages 1263 can open into ports in an interior region 1269 (e.g., an inside radius) of the spindle shaft 1284. As discussed above, an inside threaded region 1258 can be included to engage and retain an FSW tool (e.g., using a left-hand thread or as specified to avoid backing the tool out of the spindle shaft 1284 during an FSW operation).

FIG. 12E illustrates generally a cut-away view of a static portion 1286 of the compact spindle assembly of FIG. 12A and FIG. 12B. A region 1258 can accommodate a rim of the spindle shaft (shown in FIG. 12C and FIG. 12D) and cup (shown in FIG. 12G), providing a portion of a manifold for a rotary fluidic coupling for coolant circulation. The static portion 1286 can also help to retain and secure the spindle shaft within the spindle housing. As mentioned above and discussed below, the static portion 1286 could be replaced or modified to provide an anvil or other surface, such as having an adjustable extension to contact a surface of a tubular structure or other structure opposite a surface being welded to assist in neutralizing a reaction force imparted on the FSW tool in response to the forging force.

FIG. 12F illustrates generally a cut-away view of a spindle housing 1285 of the compact spindle assembly of FIG. 12A and FIG. 12B. The spindle housing can be screwed or bolted to the static portion 1286 shown in FIG. 12E and can provide one or more bearing surfaces such as an axial bearing surface 1249. The spindle housing 1285 can include or define one or more passages 1259. The passages can be used for circulation of coolant, or sized and shaped to permit optical or electrical signal lines to be routed through the spindle housing 1285, such as for monitoring of the FSW tool.

FIG. 12G illustrates generally a cup 1283 of the compact spindle assembly that can establish cooling passages 1263 that align with corresponding passages in the spindle shaft when the cup 1283 is placed within the spindle shaft. As shown and described above, the configuration of the various portions of the compact spindle assembly can support tool cooling, temperature (or other process parameter monitoring), in a configuration sized and shaped to form friction stir welded joints in confined areas, such as on an interior face (e.g., internal diameter) of a tubular structure. Such an approach can be used to form FSW joints on side plates of a reactor core fuel element in a manner similar to the examples discussed above involving exterior or outer-diameter welding.

A wheel, roller, or other tool can follow the FSW tool, such as while a joint or other friction-stirred region is still plastic, such as to burnish, flatten, smoothen a surface including a portion of a joint (e.g., a friction-stir weld) that has been formed using a friction stir tool.

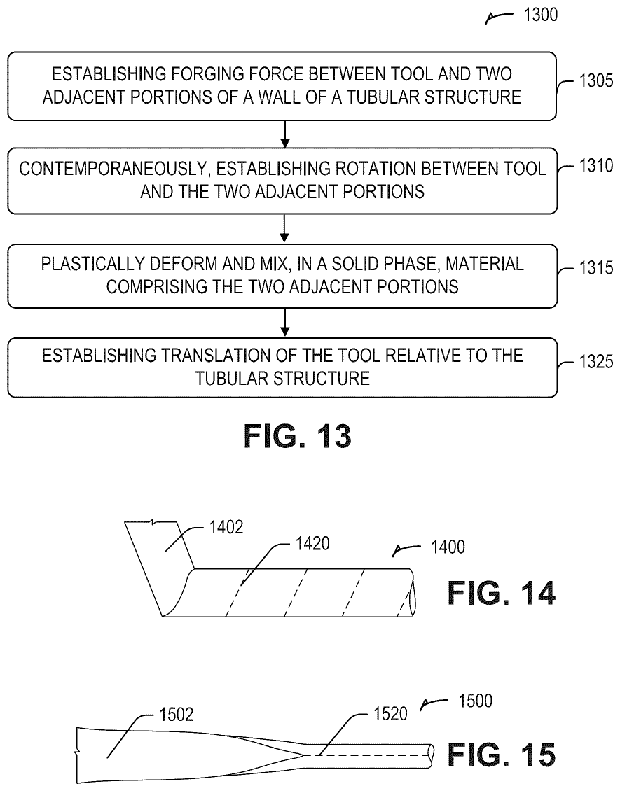

As an illustrative example of a technique enabled by the compact spindle assembly, FIG. 13 shows a technique 1300, such as a method for performing a friction stir welding (FSW) to form a tubular structure such as a pipe. At 1305, the technique 1300 can include establishing a forging force between an FSW tool and two adjacent portions of a wall of a tubular structure, and contemporaneously at 1310, rotation can be established between the tool and the two adjacent portions. In this manner, at 1315, material comprising the two adjacent portions is plastically deformed in the solid phase, and mixed, forming a welded joint. At 1325, the tool can be translated relative to the tubular structure along a specified weld path. For example, as discussed below, this can include forming a butt joint between two portions of sheet or other stock formed into a tubular shape. Unlike fusion welding, grooves or chamfered edges do not need to be machined or formed in the wall in the region of the weld. Use of a compact spindle assembly enables formation of such joints in a confined interior-facing space of the tubular structure, such as avoiding a protruding seam on an exterior surface of the tubular structure.

For example, FIG. 14 illustrates generally an illustrative example 1400 of a technique to form a tubular structure from flat material 1402 (e.g., sheet) according to the method of FIG. 13, where a spiral weld 1420 configuration is used. Use of a compact spindle assembly within an enclosed or otherwise confined tubular structure allows the spiral weld 1420 to be formed on an inside face. Similarly, FIG. 15 illustrates generally an illustrative example 1500 of a technique to form a tubular structure from flat material 1502 (e.g., sheet) according to the method of FIG. 13, where a longitudinal weld 1520 configuration is used.

As discussed generally in this document, establishing rotation, forging force, or translation, or combinations thereof of a tool relative to a workpiece need not require the tool to be moving and the workpiece to be static. For example, as discussed above in relation to FIG. 7A and FIG. 7B, the work piece can be rotated using a turntable, and the forging force can be provided by engaging the tool with the work piece and rotating the tool using a spindle.

### Various Notes

Example 1 can include an apparatus for performing friction stir welding (FSW) on an interior face of a workpiece, the apparatus comprising: a support arm coupled with or comprising a spindle housing; a spindle shaft, supported by the spindle housing; and a tool removably coupled to the spindle shaft, the tool comprising a pin protruding outward from a face of the tool; wherein the spindle shaft and tool are oriented to extend laterally outward from the support arm to engage an interior face of a workpiece where a forging force and rotation between a tool and the workpiece are established; and wherein the support arm, spindle shaft, spindle housing, and tool are sized and shaped to fit within a cross section defined by the workpiece when extended within the workpiece by the support arm.

In Example 2, the apparatus of Example 1 can include that the forging force is transmitted through the support arm and spindle housing to the spindle shaft.

In Example 3, the apparatus of Example 2, can include that the support arm is mechanically actuated by a frame configured to transmit the forging force through the support arm.

In Example 4, the apparatus of any of Examples 1 through 3 can include that the rotation of the spindle shaft is mechanically driven through the support arm.

In Example 5, the apparatus of Example 4 can include that the rotation of the spindle shaft is driven by a belt traversing the support arm.

In Example 6, the apparatus of Example 5 can include that rotation from the belt is imparted on the spindle shaft using a splined configuration.

In Example 7, the apparatus of any of Examples 1 through 7 can include that the spindle shaft defines cooling fluid passages; and wherein the spindle housing defines a passage for a cooling fluid to be supplied to and returned from the spindle shaft.

In Example 8, the apparatus of Example 7 can include that the spindle shaft is supported by a cup defining cooling fluid passages that align with the cooling fluid passages of the spindle shaft.

In Example 9, the apparatus of any of Examples 7 or 8 can include a supply line and a return line for the cooling fluid are housed within the support arm.

In Example 10, the apparatus of any of Examples 7 through 9 can include that the spindle housing defines one or more passages.

In Example 11, the apparatus of Example 10 can include that the one or more passages are sized and shaped to permit optical or electrical signal lines to be routed through the spindle housing for monitoring of the tool.

In Example 12, the apparatus of Example 10 can include that the one or more passages comprise cooling fluid passages.

In Example 13, the apparatus of any of Examples 1 through 12 can include that the spindle shaft comprises a threaded region, and that the apparatus comprises a pre-load nut configured to engage to the threaded region to at a face of the spindle shaft and spindle housing adjacent to the tool.

In Example 14, the apparatus of any of Examples 1 through 13 can include that the spindle shaft is mechanically coupled with a wireless transmitter.

In Example 15, the apparatus of Example 14 can include that the wireless transmitter is configured to transmit data indicative of one or more monitored parameters.

In Example 16, the apparatus of Example 15 can include that the one or more monitored parameters include a temperature. a rotational velocity associated with the tool, a rotational position of the tool, a force associated with the tool, or combinations thereof.

In Example 17, the apparatus of any of Examples 15 or 16 can include that the spindle housing comprises a wireless receiver configured to receive the transmitted data.

In Example 18, the apparatus of any of Examples 1 through 17 can include that the tool comprises at least one spiral feature defined by a protrusion or a recess extending outward or inward from a face of the tool in an axial direction parallel to the forging force.

In Example 19, the apparatus of Example 18 can include that the spiral is arranged to directed material toward a center of the face in response to rotation of the tool.

In Example 20, the apparatus of any of Examples 18 or 19 can include that the tool defines a shoulder on the face of the tool extending inward along the face toward a center of the face from an edge of the tool toward an edge or a start of the at least one spiral feature.

In Example 21, the apparatus of any of Examples 1 through 20 can include that the tool comprises a pin protruding outward from a face of the tool.

In Example 22, the apparatus of Example 21 can include that the pin comprises two or more flat regions on an outer diameter of the pin.

In Example 23, the apparatus of any of Examples 21 or 22 can include that an outer diameter of the pin comprises one or more sets of ridges or grooves extending at least partially circumferentially around the pin.

In Example 24, the apparatus of any of Examples 21 through 23 can include that a length of a protrusion of the pin from the face comprises between 20% and 70% of a thickness of the workpiece.

Example 25 can include a tool for friction stir welding (FSW) to plastically deform and mix, in a solid phase, a material, when the tool is subject to a forging force and rotation relative to the material, the tool comprising: a shank configured to be engaged by a tool holder; and a face defined by a body of the tool, the face defining a shoulder extending along the face from an edge of the tool inward toward a center of the face; a pin protruding outward from the face of the tool centered at the center of the face; and at least one spiral feature defined by a protrusion or a recess extending outward or inward from a face of the tool in an axial direction parallel to the forging force, the at least one spiral feature located between the shoulder and the pin.

In Example 26, the tool of Example 25 can include that the pin comprises two or more flat regions on an outer diameter of the pin.

In Example 27, the tool of Example 26 can include that an outer diameter of the pin comprises one or more sets of ridges or grooves extending at least partially circumferentially around the pin.

In Example 28, the tool of any of Examples 25 through 27 can include that a length of a protrusion of the pin from the face comprises between 20% and 70% of a thickness of a workpiece comprising the material.

In Example 29, the tool of Example 28 can include that the workpiece comprises a tubular structure.

In Example 30, the tools of any of Examples 25 through 29 can include that the shank comprises a threaded region to engage the tool with the tool holder.

In Example 31, the tool of any of Examples 25 through 30 can include that the shoulder comprises a region having a uniform radius around the face of the tool, extending inward toward an edge or a start of the at least one spiral feature.

Example 32 can include a method for forming a tubular structure using friction stir welding (FSW), the method comprising: establishing a forging force and rotation between a tool and two adjacent portions of a wall for the tubular structure to plastically deform and mix, in a solid phase, material comprising the two adjacent portions to form a joint between the two adjacent portions; and contemporaneously with the establishing the forging force and the rotation, establishing translation of the tool relative to the tubular structure to continue the joint to form a seam extending along an interface formed by the two adjacent portions of the wall; wherein the forging force and rotation are established on interior-facing regions of the two adjacent portions of the wall.

In Example 33, the method of Example 32 can include forming a sheet of the material into a tubular shape defining the wall, including establishing the interface defined by the two adjacent portions.

In Example 34, the method of any of Examples 32 or 33 can include that the forging force is generally applied in a direction toward the wall from a direction perpendicular to a surface of the wall; and wherein the rotation is established in a plane tangent to a surface of the wall.

In Example 35, the method of any of Examples 32 through 34 can include that the seam comprises a butt joint extending longitudinally along the tubular structure.

In Example 36, the method of any of Examples 32 through 34 can include that the seam comprises a spiral joint extending helically around the tubular structure.

In Example 37, the method of Example 36 can include that the seam comprises a first spiral seam; and wherein the method comprises forming a second spiral seam extending spirally in a direction opposite the first spiral seam between turns of the first spiral seam.

In Example 38, the method of any of Examples 32 through 34 can include that the seam comprises a butt joint extending circumferentially around two sections of the tubular structure joining together the two sections.

In Example 39, the method of any of Examples 32 through 38 can include that the forging force and rotation are established at the tool using a spindle sized and shaped for positioning inside an inner diameter of the tubular structure.

In Example 40, the method of Example 32 can include that the establishing translation of the tool to form the seam comprises rotating the tubular structure relative to the tool.

In Example 41, the method of any of Examples 32 through 40 can include establishing a reaction force to the forging force using a support structure.

In Example 42, the method of Example 41 can include that the support structure engages the tubular structure using at least two rollers.

In Example 43, the method of any of Examples 32 through 42 can include that the tool comprises at least one spiral feature defined by a protrusion or a recess extending outward or inward from a face of the tool in an axial direction parallel to the forging force.

In Example 44, the method of Example 43 can include that the spiral is arranged to direct material toward a center of the face in response to rotation of the tool.

In Example 45, the method of any of Examples 32 through 44 can include that the tool comprises a pin protruding outward from a face of the tool.

In Example 46, the method of Example 45 can include that the pin comprises two or more flat regions on an outer diameter of the pin.

In Example 47, the method of any of Examples 45 or 46 can include that an outer diameter of the pin comprises one or more sets of ridges or grooves extending at least partially circumferentially around the pin.

In Example 48, the method of any of Examples 45 through 47 can include that a length of a protrusion of the pin from the face comprises between 20% and 70% of a thickness of the wall of the tubular structure.

In Example 49, the method of any of Examples 32 through 48 can include traversing the seam using a roller to modify a surface of the seam formed by the tool.

In Example 50, the method of any of Examples 32 through 49, comprising monitoring a temperature at or near an interface between the tool and tubular structure, and in response, using the monitored temperature to control at least one of the forging force, rotational velocity, translational velocity, or tool orientation.

Example 51 can include a method for forming a joint using friction stir welding (FSW), the method comprising: positioning a plate against a first face of a base structure, the plate extending outward from the first face of the base structure; establishing a forging force and rotation between a tool and a second face of the base structure opposite the first face to plastically deform and mix, in a solid phase, through the base structure, material comprising the base structure and material comprising the plate to form a joint between base structure and the plate; and contemporaneously with the establishing the forging force and the rotation, establishing translation of the tool relative to the second face of the base structure to define a specified weld path.

In Example 52, the method of Example 51 can include that the first plate is amongst a plurality of plates extending outward from the first face of the base structure; and wherein the establishing translation of the tool relative to the second face of the base structure along a weld path forms respective joints between the plurality of plates and the base structure.

In Example 53, the method of any of Examples 51 or 52 can include that the base structure is cylindrical.

In Example 54, the method of any of Examples 51 through 53 can include that the weld path is circumferential about the base structure.

In Example 55, the method of any of Examples 51 through 53 can include that the weld path extends spirally along the base structure.

In Example 56, the method of Example 55 can include that the weld path comprises a first spiral weld path and the method can include forming a second weld path extending spirally in a direction opposite the first spiral weld path between turns of the first spiral weld path.

In Example 57, the method of any of Examples 51 through 53 can include that the weld path extends axially along the base structure.

In Example 58, the method of any of Examples 51 through 56 can include that the establishing translation of the tool comprises rotating the base structure relative to the tool.

In Example 59, the method of any of Examples 51 through 58 can include that the base structure defines an enclosed cross section, and that the first face is oriented outward, and that the second face is oriented inward.

In Example 60, the method of Example 59 can include that the forging force and rotation are established at the tool using a spindle sized and shaped for positioning inside the enclosed cross section of the base structure.

In Example 61, the method of any of Examples 51 through 59 can include that the base structure defines an enclosed cross section, and that the first face is oriented inward, and that the second face is oriented outward.

In Example 62, the method of Example 61 can include that the tool comprises a first tool, and that the method comprises establishing another forging force and rotation between a second tool and the second face of the base structure in a location to oppose the forging force established at the first tool, to plastically deform and mix, in the solid phase, material comprising the base structure and material comprising another plate to form another joint between base structure and another plate.

In Example 63, the method of any of Examples 51 through 62 can include that the positioning a first plate against a first face of a base structure comprises locating the plate in a slot in the base structure.

In Example 64, the method of Example 63, comprising forming the slot in the base structure.

In Example 65, the method of any of Examples 51 through 64 can include that the base structure comprises a first base structure, and that the method comprises positioning an opposite end of the plate against a first face of a second base structure, the plate extending between from the first face of the first base structure and the first face of the second base structure, establishing a forging force and rotation between the tool and a second face of the second base structure opposite the first face of the second base structure to plastically deform and mix, in a solid phase, material comprising the second base structure and material comprising the plate to form a joint between second base structure and the plate.

In Example 66, the method of Example 65 can include that the first base structure comprises an outer plate and the second base structure comprises an inner plate.

In Example 67, the method of Example 66 can include that the outer plate and the inner plate are cylindrical.

In Example 68, the method of any of Examples 66 or 67 can include that the plate extending between the outer plate and the inner plate is curved.

In Example 69, the method of any of Examples 65 through 68 can include that the first base structure, second base structure, and plate form a portion of a heat exchanger assembly comprising multiple plates extending between the first base structure and the second base structure.

In Example 70, the method of any of Examples 65 through 69 can include that the first base structure, second base structure, and plate form a portion of a reactor fuel assembly comprising multiple plates extending between the first base structure and the second base structure.

In Example 71, the method of any of Examples 51 through 70, comprising traversing the weld path using a roller to modify a surface of a seam formed by the tool.

In Example 72, the method of any of Examples 51 through 71, comprising monitoring a temperature at or near an interface between the tool and the base structure, and in response, using the monitored temperature to control at least one of the forging force, rotational velocity, translational velocity, or tool orientation.

In Example 73, the method of any of Examples 51 through 72, comprising establishing a reaction force to the forging force using a support structure.

In Example 74, the method of Example 73 can include that the support structure engages the base structure using at least two rollers.

In Example 75, the method of any of Examples 51 through 74 can include that the tool comprises at least one spiral feature defined by a protrusion or a recess extending outward or inward from a face of the tool in an axial direction parallel to the forging force.

In Example 76, the method of Example 75 can include that the spiral is arranged to direct material toward a center of the face in response to rotation of the tool.

In Example 77, the method of any of Examples 75 or 76 can include that the tool defines a shoulder on the face of the tool extending inward along the face toward a center of the face from an edge of the tool toward an edge or a start of the at least one spiral feature.

In Example 78, the method of any of Examples 51 through 77 can include that the tool comprises a pin protruding outward from a face of the tool.

In Example 79, the method of Example 78 can include that the pin comprises two or more flat regions on an outer diameter of the pin.

In Example 80, the method of any of Examples 78 or 79 can include that an outer diameter of the pin comprises one or more sets of ridges or grooves extending at least partially circumferentially around the pin.

In Example 81, the method of any of Examples 78 through 80 can include that a length of a protrusion of the pin from the face comprises between 20% and 70% of a thickness of the base structure.

In Example 82, the method of any of Examples 51 through 81 can include that at least one of the base structure or the plate comprises an aluminum alloy.

Example 83 can include a method for forming a joint using friction stir welding (FSW), the method comprising: positioning a plate against a first face of a cylindrical base structure within a slot in the base structure, the plate extending outward from the first face of the base structure, establishing a forging force and rotation between a tool and a second face of the base structure opposite the first face to plastically deform and mix, in a solid phase, through the base structure, material comprising the base structure and material comprising the plate to form a joint between base structure and the plate, and contemporaneously with the establishing the forging force and the rotation, establishing translation of the tool relative to the second face of the base structure to define a specified weld path. The first plate can be amongst a plurality of plates extending outward from the first face of the base structure, and the establishing translation of the tool relative to the second face of the base structure along a weld path can form respective joints between the plurality of plates and the base structure.

Example 84 can include a reactor fuel assembly fabricated using the method of any of examples 51 through 83.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for forming a tubular structure using friction stir welding (FSW), the method comprising:
establishing a forging force and rotation between a tool and two adjacent portions of a wall for the tubular structure to plastically deform and mix, in a solid phase, material comprising the two adjacent portions to form a joint between the two adjacent portions; and
contemporaneously with the establishing the forging force and the rotation, establishing translation of the tool relative to the tubular structure to continue the joint to form a seam extending along an interface formed by the two adjacent portions of the wall;
wherein the forging force and rotation are established on interior-facing regions of the two adjacent portions of the wall.

2. The method of claim 1, comprising forming a sheet of the material into a tubular shape defining the wall, including establishing the interface defined by the two adjacent portions.

3. The method of claim 1, wherein the forging force is generally applied in a direction toward the wall from a direction perpendicular to a surface of the wall; and
wherein the rotation is established in a plane tangent to a surface of the wall.

4. The method of claim 1, wherein the seam comprises a butt joint extending longitudinally along the tubular structure.

5. The method of claim 1, wherein the seam comprises a spiral joint extending helically around the tubular structure.

6. The method of claim 1, wherein the seam comprises a butt joint extending circumferentially around two sections of the tubular structure joining together the two sections.

7. The method of claim 1, wherein the forging force and rotation are established at the tool using a spindle sized and shaped for positioning inside an inner diameter of the tubular structure.

8. The method of claim 1, wherein the establishing translation of the tool to form the seam comprises rotating the tubular structure relative to the tool.

9. The method of claim 1, wherein the tool comprises at least one spiral feature defined by a protrusion or a recess extending outward or inward from a face of the tool in an axial direction parallel to the forging force.

10. The method of claim 1, wherein the tool comprises a pin protruding outward from a face of the tool.

11. The method of claim 10, wherein the pin comprises two or more flat regions on an outer diameter of the pin.

12. The method of claim 10, wherein a length of a protrusion of the pin from the face comprises between 20% and 70% of a thickness of the wall of the tubular structure.

13. An apparatus for performing friction stir welding (FSW) on an interior face of a workpiece, the apparatus comprising:
a support arm coupled with or comprising a spindle housing;
a spindle shaft, supported by the spindle housing; and
a tool removably coupled to the spindle shaft, the tool comprising a pin protruding outward from a face of the tool;
wherein the spindle shaft and tool are oriented to extend laterally outward from the support arm to engage an interior face of a workpiece where a forging force and rotation between a tool and the workpiece are established; and
wherein the support arm, spindle shaft, spindle housing, and tool are sized and shaped to fit within a cross section defined by the workpiece when extended within the workpiece by the support arm.

14. The apparatus of claim 13, wherein the forging force is transmitted through the support arm and spindle housing to the spindle shaft; and
wherein the rotation of the spindle shaft is mechanically driven through the support arm.

15-16. (canceled)

15. The apparatus of claim 13, wherein the spindle shaft is mechanically coupled with a wireless transmitter, the wireless transmitter configured to transmit data indicative of one or more monitored parameters, the one or more monitored parameters comprising a temperature, a rotational velocity associated with the tool, a rotational position of the tool, a force associated with the tool, or combinations thereof.

16. A tool for friction stir welding (FSW) to plastically deform and mix, in a solid phase, a material, when the tool is subject to a forging force and rotation relative to the material, the tool comprising:
a shank configured to be engaged by a tool holder; and
a face defined by a body of the tool, the face defining a shoulder extending along the face from an edge of the tool inward toward a center of the face;
a pin protruding outward from the face of the tool centered at the center of the face; and
at least one spiral feature defined by a protrusion or a recess extending outward or inward from a face of the tool in an axial direction parallel to the forging force, the at least one spiral feature located between the shoulder and the pin.

17. The tool of claim 16, wherein the pin comprises two or more flat regions on an outer diameter of the pin.

18. The tool of claim 16, wherein an outer diameter of the pin comprises one or more sets of ridges or grooves extending at least partially circumferentially around the pin.

19. A method for forming a joint using friction stir welding (FSW), the method comprising:
positioning a plate against a first face of a base structure, the plate extending outward from the first face of the base structure;
establishing a forging force and rotation between a tool and a second face of the base structure opposite the first face to plastically deform and mix, in a solid phase, through the base structure, material comprising the base structure and material comprising the plate to form a joint between base structure and the plate; and
contemporaneously with the establishing the forging force and the rotation, establishing translation of the tool relative to the second face of the base structure to define a specified weld path.

20. The method of claim 19, wherein the first plate is amongst a plurality of plates extending outward from the first face of the base structure; and
wherein the establishing translation of the tool relative to the second face of the base structure along a weld path forms respective joints between the plurality of plates and the base structure.
